(19) United States
(12) Patent Application Publication
(10) Pub. No.: US 2012/0059713 A1
(43) Pub. Date: Mar. 8, 2012

(54) Matching Advertisers and Users Based on Their Respective Intents

(75) Inventors: Daniel Galas, Oakland, CA (US); Veeravich Thi Thumasathit, Palo Alto, CA (US); Murthy V. Nukala, San Mateo, CA (US); Richard Edward Chatwin, Los Altos Hills, CA (US); Alessandro Magnani, Menlo Park, CA (US); Benjamin David Foster, Arlington, VA (US); Alan Coleman, Lafayette, CA (US); Manish Khettry, Mountain View, CA (US); Siva Chandrasekar, Cupertino, CA (US); Nitin Gupta, San Francisco, CA (US); Srinidhi Ramesh Kondaji, Mountain View, CA (US); Venkatesh Natarajan, San Jose, CA (US); Nitin Duggal, Menlo Park, CA (US)

(73) Assignee: ADCHEMY, INC., Foster City, CA (US)

(21) Appl. No.: 13/219,433

(22) Filed: Aug. 26, 2011

Related U.S. Application Data
(60) Provisional application No. 61/377,648, filed on Aug. 27, 2010.

(51) Int. Cl. G06Q 30/02

(52) U.S. Cl. 705/14.49

(57) ABSTRACT

In one embodiment, a method includes deriving a user intent from user information associated with a user, selecting an advertiser intent that aligns with the user intent, and then advertising to the user based on the advertiser intent that aligns with the user intent.

### RELATED APPLICATIONS

This application claims the benefit, under 35 U.S.C. §119(e), of U.S. Provisional Patent Application No. 61/377,648, filed 27 Aug. 2010.

### TECHNICAL FIELD

The present disclosure generally relates to search engines and search-engine-based marketing and advertisements.

### BACKGROUND

The internet provides a versatile medium for advertising. An advantage of internet advertising over more traditional advertising (such as advertising on billboards or in newspapers or magazines) is more customized or personal advertising, even down to the level of individual users. More personalized advertising tends to be more effective than less personalized advertising, and personalized advertising tends to be more effective when the advertisements are specifically directed at users who are more likely to be interested in the advertisements. Such users are less likely to discard or ignore the advertisements, and as a result the advertisements are more likely to generate revenue. At the same time, more personalized advertising typically reduces advertising costs for advertisers, as the advertisements are usually delivered to fewer users.

Advertisements are commonly used on the internet to promote various products (such as, for example, physical products, software products, or services). Advertisements may include, for example, banner advertisements, links to webpages, images, video, text, etc. The various advertisements used to promote products on the internet may be displayed according to a variety of formats, such as, for example, in conjunction with a ranked result set in response to a search engine query. The advertisements displayed to a user may be selected, redirecting the user to a website providing the product or service advertised.

Search engine advertisers may show ads to users of search engines on a cost-per-click basis. Advertisers may bid on one or more keywords, including groups of related keywords, which are referred to as advertisement groups. Advertisers may select keywords and then assign cost-per-click bids, ad copy, and click-through URLs to each of the keywords. Users of the search engine may then enter a query into a search engine (e.g., Google, Yahoo!, Bing) and the search engine may match queries to keywords and display relevant ads to the users, sorting the ads based on cost-per-click bids, click-through rate, and a host of proprietary algorithms. Advertisers participating in such an auction-based system may face the daunting challenge of managing and optimizing the ongoing bid process, for example, managing and optimizing bids for thousands or millions of keywords or groups of keywords (e.g., advertisement groups).

### BRIEF DESCRIPTION OF THE DRAWINGS

FIG. 1 illustrates an example system comprising parties involved in digital-marketing campaigns.

FIG. 2A illustrates an example intent map.

FIG. 2B illustrates the relationships between user information, keywords, intents, and products.

FIG. 2C illustrates an example of intent-based keyword portfolio management.

FIG. 3A illustrates an example method for matching products and users based on their respective intents.

FIG. 3B illustrates an example method for matching advertiser intents to keywords.

FIG. 4 illustrates an example search-engine-marketing platform in an example network environment.

FIG. 5 illustrates an example computer system.

### DESCRIPTION OF EXAMPLE EMBODIMENTS

### System Overview

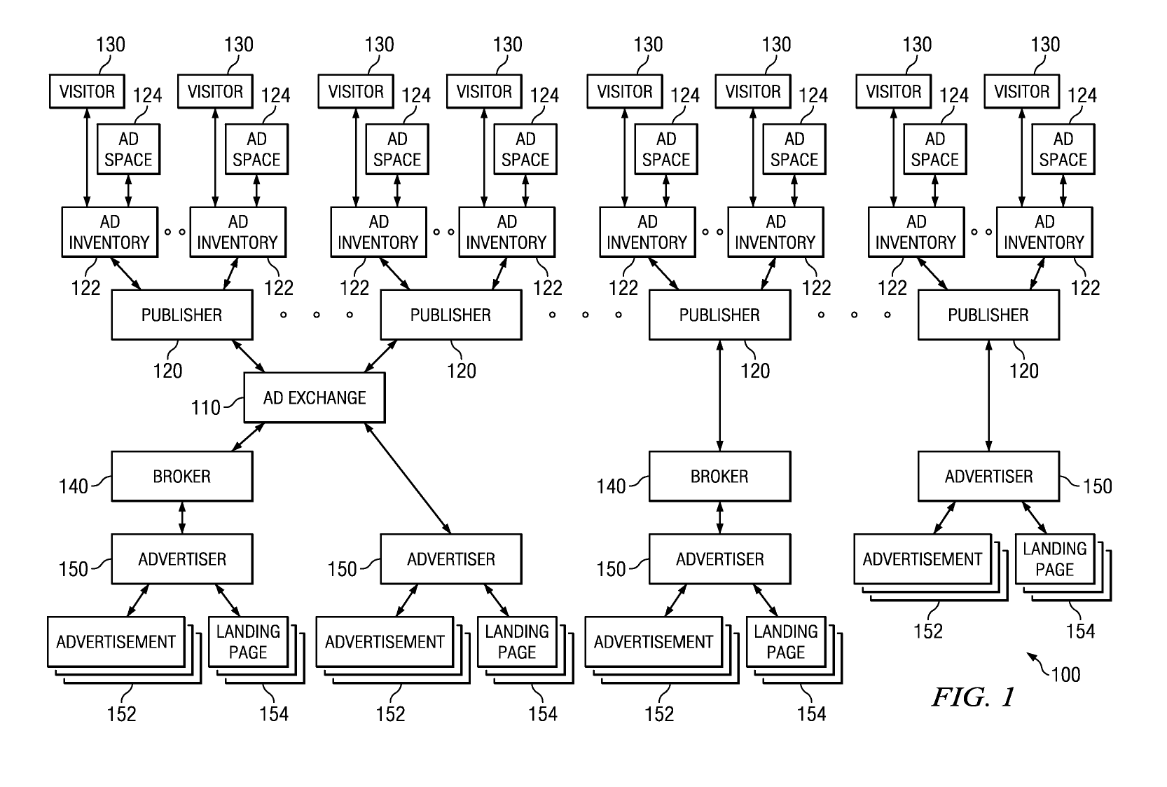

FIG. 1 illustrates an example system 100 comprising parties involved in digital-marketing campaigns and the relationships between the parties. System 100 may include one or more ad exchanges 110, one or more publishers 120, one or more visitors 130, one or more brokers 140, and one or more advertisers 150. Each ad exchange 110 may service one or more publishers 120, one or more brokers 140, or one or more advertisers 150. Each publisher 120 may have one or more available ad inventories 122 at any given time, and each ad inventory 122 may include an ad space 124 for placing an advertisement and a visitor 130 to whom the advertisement is to be presented. Each broker 140 may represent one or more advertisers 150 and manage digital-marketing campaigns for these advertisers 150. Each advertiser 150 may have one or more advertisements 152 and one or more landing pages 154 to be presented to the various visitors 130. A publisher 120 may interact with brokers 140 or advertisers 150 directly or may employ an ad exchange 110 to interact with brokers 140 or advertisers 150. Although FIG. 1 illustrates a particular arrangement of ad exchanges 110, publishers 120, ad inventories 122, ad spaces 124, visitors 130, brokers 140, advertisers 150, advertisements 152, and landing pages 154, this disclosure contemplates any suitable arrangement of ad exchanges 110, publishers 120, ad inventories 122, ad spaces 124, visitors 130, brokers 140, advertisers 150, advertisements 152, and landing pages 154. As an example and not by way of limitation, two or more of ad exchange 110, publisher 120, visitor 130, broker 140, or advertisers 150 may be connected to each other directly, bypassing other parties. As another example, two or more of ad exchange 110, publisher 120, ad inventory 122, ad space 124, visitor 130, broker 140, advertiser 150, advertisement 152, or landing page 154 may be physically or logically co-located with each other in whole or in part. Moreover, although FIG. 1 illustrates a particular number of ad exchanges 110, publishers 120, ad inventories 122, ad spaces 124, visitors 130, brokers 140, advertisers 150, advertisements 152, and landing pages 154, this disclosure contemplates any suitable number of ad exchanges 110, publishers 120, ad inventories 122, ad spaces 124, visitors 130, brokers 140, advertisers 150, advertisements 152, and landing pages 154.

In particular embodiments, ad exchange 110, publisher 120, visitor 130, broker 140, or advertiser 150 may be a network-addressable computing system. Ad exchange 110, publisher 120, visitor 130, broker 140, or advertiser 150 may generate, store, receive, and transmit data, such as, for example, user information, search queries, search results, webpages, advertisements, or other suitable data. Ad exchange 110, publisher 120, visitor 130, broker 140, or advertiser 150 may be accessed by the other components illustrated in FIG. 1 either directly or via a suitable network. In particular embodiments, a visitor 130 may be any suitable client system, which may access ad exchange 110, publisher 120, ad inventory 122, ad space 124, broker 140, advertiser 150, advertisement 152, or landing page 154 directly, via a suitable network, or via a third-party system. A visitor 130 may be a user accessing another component of system 100 via a suitable computing device, such as, for example, a personal computer, a laptop, a cellular phone, a smart phone, or a computing tablet.

This disclosure contemplates any suitable network 110. As an example and not by way of limitation, one or more portions of network 110 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 110 may include one or more networks 110.

Connections may connect ad exchanges 110, publishers 120, visitors 130, brokers 140, or advertisers 150 to a network or to each other. This disclosure contemplates any suitable connections. In particular embodiments, one or more connections include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) connections. In particular embodiments, one or more connections each include an ad hoc network, an intranet, an extranet, a VPN, a LAN, a WLAN, a WAN, a WWAN, a MAN, a portion of the Internet, a portion of the PSTN, a cellular telephone network, another connection, or a combination of two or more such connections. Connections need not necessarily be the same throughout the system. One or more first connections may differ in one or more respects from one or more second connections.

Customizing search-engine-marketing campaigns for specific segments of consumers often improves campaign performance, which in turn improves the volume of sales from, the revenue generated by, or the return-on-investment of the search-engine-marketing campaigns. However, it may be difficult for the advertisers (also referred to as “search-engine marketers” or “marketers”) to achieve mass customization, at least partly because search-engine-marketing campaigns tend to be path dependent. The “best” (or the most customized user experience) is often a function of a search engine marketing value chain. At each stage along a search engine marketing value chain, search-engine-marketing campaign customization for any given consumer should take into consideration not only relevant information on the current stage along the search-engine-marketing value chain but as much relevant information as is available from previous stages along the search-engine-marketing value chain as well. As an example and not by way of limitation, the “best” advertisement (ad) for a particular consumer may be a function of how the advertiser purchases the advertising media; who the consumer (also referred to as a “user” or “visitor”) being targeted is; which publisher publishes the advertisement; the placement of the advertisement; the corresponding search term (if applicable); whether the consumer has previously visited the web site or the advertiser; other consumer/user information, or two or more such factors. The “best” landing page for a particular user may be a function of how the advertising media is purchased; what corresponding advertisement has been presented; where in the advertisement the consumer has clicked; or other suitable factors. Optimization that does not take into consideration relevant information from previous stages of the search engine marketing value chain may tend to lead to suboptimal campaign performance.

There may be multiple parties involved in a search-engine-marketing campaign. An advertiser may be considered the sponsor of the search-engine-marketing campaign. Typically, an advertiser wishes to sell one or more particular products. As used herein, the term “product” may refer to a physical product, a software product, a service, an intangible product (such as, for example, intellectual property), another suitable good or service, or two or more such goods or services. To do this, the advertiser may conduct a search-engine-marketing campaign to present various advertisements relating to the services or products. Users are people to whom the advertisements may be presented. They are the potential customers of the advertisers or the potential buyers of the services or products. An advertiser may target a search-engine-marketing campaign to visitors in general, to specific groups of visitors, or to individual visitors. Generally, the desired outcome of a search-engine-marketing campaign is for many visitors to purchase the services or products that the advertiser wishes to sell.

The advertisements are placed in advertising spaces (or ad spaces) so that they may be presented to the visitors. In the case of search-engine marketing, the ad spaces exist in the digital media, such as the Internet. For example, portions of webpages may be used to present advertisements to people viewing the webpages and these portions of the webpages may be considered ad spaces. Sometimes, an advertiser may have its own ad spaces, but more often the advertiser has too few or does not own any ad spaces. Instead, the advertiser may purchase ad spaces from publishers for placing their advertisements. A publisher is a party that owns and sells ad spaces to advertisers and presents the advertisements placed in its ad spaces to visitors on behalf of the advertisers.

A publisher may own any number of advertising inventories at any given time. In particular embodiments, an advertising inventory (or ad inventory) may include a particular ad space that is currently available for placing an advertisement to be presented to a particular visitor. In particular embodiments, an ad inventory may also include information concerning the ad space and information concerning the visitor or generated by the visitor to whom the advertisement is to be presented. Such information may describe characteristics of the ad space, the visitor, or both. Information concerning the ad space, the visitor, or generated by the visitor may be referred to as user information.

When an ad inventory becomes available, the publisher that owns the ad inventory may request multiple advertisers to bid on the ad inventory. Alternatively, advertisers may submit bids in advance of an ad inventory being available in anticipation of the ad inventory becoming available. Each of the advertisers wishing to place its advertisement in the ad space of the ad inventory may submit a bid for the ad inventory. The publisher may then select a winning bid (such as, for example, the highest bid, the bid the publisher believes will generate the most volume or revenue) and the advertiser submitting the winning bid may have its advertisement placed in the ad space and presented to the visitor of the ad inventory. If a webpage contains multiple ad spaces and thus causes multiple ad inventories to become available, the publisher may conduct individual auctions for each ad inventory or one auction for all the ad inventories and then select multiple winning bids for the multiple ad inventories. However, not all ad inventories are sold via auctions. In particular embodiments, a contract may exist between a publisher and an advertiser that governs the selling of the ad inventories from the publisher to the advertiser. In particular embodiments, ad inventories may be sold via an ad network.

Publishers may sell their ad inventories directly (such as in the case of search engines) or via a third-party service platform, which may be referred to as an advertising exchange (or ad exchange). An ad exchange may facilitate the bidding process of the ad inventories on behalf of the publishers. In particular embodiments, when an ad inventory becomes available, an ad exchange may be notified with the specific information concerning the ad inventory. The ad exchange may in turn notify the advertisers about the ad inventory and ask the advertisers to bid on the ad inventory. The advertisers may submit bids to the ad exchange, and the ad exchange may select a winning bid and forward the information to the publisher. The winning advertiser may then place one of its advertisements in the ad space of the ad inventory. Example ad exchanges include, without limitation, AdECN, RIGHT MEDIA, and DOUBLECLICK.

Some advertisers may interact with publishers or ad exchanges directly, which may include, for example, monitoring available ad inventories, determining bid amounts, and submitting bids. Other advertisers may employ third-party brokers to manage their digital-marketing campaigns and interact with the publishers or ad exchanges on their behalf. In particular embodiments, the brokers may attempt to achieve the advertisers' marketing objective for the digital-marketing campaigns by customizing various aspects of the marketing activities.

### Social Graphs and Social Networking Systems

In particular embodiments, a component of system 100 may interface with a social graph on a social networking system. User information may include information about a user of a social networking system. Social graphs are models of connections between entities (e.g., individuals, users, contacts, friends, users, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph.

The minimum number of edges required to connect a user to another user is considered the degree of separation between them. For example, where a first user and second user are directly connected (one edge), they are deemed to be separated by one degree of separation. The second user would be a so-called “first-degree friend” of the first user. Where the first and second users are connected through one other user (two edges), they are deemed to be separated by two degrees of separation. The second user would be a so-called “second-degree friend” of the first user. Where the first and second users are connected through N edges (or N−1 other users), they are deemed to be separated by N degrees of separation. The second user would be a so-called “Nth-degree friend” of the first user.

Within the social graph, each user has a social network. A user's social network includes all other users in the social graph within Nₘₐₓ degrees of the user, where Nₘₐₓ is the maximum degree of separation allowed by the system managing the social graph (such as, for example, a third-party social networking system or publisher 120). As an example and not by way of limitation, if Nₘₐₓ equals 1, then each user's social network includes only first-degree friends. As another example and not by way of limitation, if Nₘₐₓ is unlimited, then each user's social network may be coextensive with the social graph, or at least coextensive with any social network in the social graph that is contiguous with a particular user's social network.

In particular embodiments, a social graph may be managed and hosted by a third-party system. As an example and not by way of limitation, a social graph may be managed and hosted by Facebook, Google+, Myspace, Twitter, or another suitable social networking system. One or more components of system 100 may access the social graph and related social-graph information on the third-party system (such as, for example, using a suitable API). In particular embodiments, a social graph may be managed and hosted by one or more components of system 100, such as, for example, ad exchange 110, publisher 120, visitor 130, broker 140, or advertiser 150. Although this disclosure describes particular social graphs hosted and managed by particular systems, this disclosure contemplates any suitable social graphs hosted and managed by and suitable systems.

In particular embodiments, the connections in a user's social network can be formed both explicitly (e.g., a user must indicated other users as “friends” or “contacts”) and implicitly (e.g., system determines edges based on user information). Unless otherwise indicated, reference to an edge between two or more nodes can be interpreted to cover both explicit and implicit social graph connections, using one or more social graphs and other factors to infer connections. The social graph connections can be unidirectional or bidirectional. The social graph connections may require mutual confirmation by the user's represented by the connected nodes. It is not a limitation of this description that two users who are deemed “friends” or “contacts” for the purposes of this disclosure are not friends or acquaintances in real life (i.e., in disintermediated interactions or the like), but that could be the case.

### Search-Engine Marketers

A search-engine-marketing platform may be operated by a publisher, an ad exchange, a broker, an advertiser, or another suitable party. In particular embodiments, an advertiser (i.e., search-engine marketer) may have one or more advertising orders (ad order). An ad order represents an order for placing an advertisement in one or more ad spaces to be presented to one or more visitors. In particular embodiments, an ad order may contain the advertisement to be presented to a visitor and one or more desired features of the ad spaces in which to place the advertisement or one or more desired features of the visitors to whom the advertisement is to be presented. In addition, in particular embodiments, an ad order may also include a default bid price that may be used to bid on the ad inventories for placing the advertisement of the ad order in the ad spaces of the ad inventories. In particular embodiments, there may be one or more keywords describing the advertisement (e.g., keywords describing the category or content of the advertisement or keywords describing the service or product being advertised) of the ad order.

An advertiser may have specific criteria associated with a search-engine-marketing campaign. The criteria may be reflected in the desired ad-space features and desired visitor features specified for the ad orders so that each ad order may target specific time, locations, consumers/users, etc. The desired features may be general or specific. As an example and not by way of limitation, the desired visitor features may include demographical information concerning the visitors, visitors having particular behavioral patterns, etc. The desired ad-space features may include where and when the ad space is presented, who owns the ad space, what event causes the ad space to become available, etc. If an advertiser is advertising about women's clothing, the advertiser may wish to target only female visitors in its search-engine-marketing campaign. In this case, an ad order may specify <gender=female> as one of its desired visitor features. If the advertiser is a regional business located in Northern California, the advertiser may wish to show its advertisements only to people in California. In this case, the ad order may further specify <location=California> as another one of its desired visitor features. If the advertiser wishes to place its advertisements with a specific publisher (e.g., Google, Yahoo!, etc.) only, the ad order may specify <publisher=Google> as one of its desired ad-space features. If the advertiser wishes to place its advertisements in webpages corresponding to a specific search query (e.g., webpage containing the search result identified for a specific search query) only, the ad order may specify the search query as another one of its desired ad-space features (e.g., ad space contained in webpages corresponding to the search query). If the advertiser wishes to present its advertisements during a particular time period (e.g., on the weekends) only, the ad order may specify “presented on Saturdays and Sundays” as another one of its desired ad-space features. Although this disclosure describes particular features describing ad spaces and visitors, this disclosure contemplates any suitable features describing ad spaces or visitors.

In addition, the advertisement in the ad order often has an associated landing page, which may also be included in the ad order. A landing page is a webpage that is presented to a visitor when the visitor clicks on the associated advertisement. The landing page usually contains content that is a logical extension of the associated advertisement. For example, if the advertisement is about a television, the associated landing page may contain a detailed description or specification of the television, various images of the television, user reviews of the television, unit price, shipping cost, or applicable tax for purchasing the television. The visitor may obtain further information and purchase the television via the landing page. In another example, if the advertisement is about college education, the landing page may contain a form having various informational fields through which the visitor may submit personal information (i.e., user information). The visitor may indicate the degree program and the school in which he is interested, his current education level and profession, his education goal, his age and gender, his annual income, and so on. The visitor may also indicate the specific additional information he is seeking, whether he wishes to be contacted by any specific schools and how, and so on. The visitor may submit the form (e.g., by clicking a “submit” button contained in the landing page) to transmit the information provided in the form to the appropriate party (e.g., the advertiser or the search-engine-marketing platform). The visitor may then be directed to a confirmation page that contains a tracking pixel, which transmits back to a search engine that the submit has occurred. The submitted information can then be used for pricing, such as, for example, if the ad is sold on a cost-per-action basis, or simply for tracking, reporting, or analytics purposes.

In particular embodiments, an advertiser may submit its ad orders to one or more publishers or one or more ad exchanges. Alternatively, a broker representing an advertiser may submit the ad orders of the advertiser to one or more publishers or one or more ad exchanges on behalf of the advertiser. Multiple advertisers or brokers may submit multiple ad orders to the same publisher or the ad exchange. The publisher or the ad exchange may use the information in the ad orders to match particular ad orders to particular ad inventories as the ad inventories become available.

Ad inventories may become available or unavailable as time passes, typically as ad spaces become available or unavailable. An ad space may become available when the webpage containing the ad space is to be constructed and presented to a visitor, which may be resulted from different types of events. For example, a visitor may explicitly request a particular webpage by entering the Uniform Resource Locator (URL) of the webpage in the visitor's browser on the client device used by the visitor. Alternatively, a visitor may click on a link of a particular webpage embedded in another webpage that the visitor is viewing and be led to the particular webpage. A visitor may also request a search engine to conduct a search on a search query, which may result in a webpage being constructed for presenting the search result identified in response to the search query to the visitor. When the webpage needs to be constructed for a particular visitor, an ad space may become available if an area in the webpage is to be used for placing an advertisement. The visitor associated with an ad inventory is often the person who caused the ad space to become available and to whom the advertisement placed in the ad space is to be presented. Consequently, an ad inventory associated with that ad space may become available. Of course, the ad-space features and the user intent included in each ad inventory may vary each time an ad inventory becomes available.

As each ad inventory becomes available, the publisher owning the ad inventory may match the ad inventory to one or more ad orders of one or more advertisers. Alternatively, an ad exchange may match the ad inventory to one or more ad orders of one or more advertisers on behalf of the publisher owning the ad inventory. Each ad order may include one or more desired features of the ad spaces in which to place the advertisement of the ad order or one or more desired features of the visitors to whom the advertisement of the ad order is presented partly because not all available ad inventories at any given time may be suitable to an advertiser. For example, if an advertiser only wishes to target its advertisements to female visitors because it is advertising women's clothing, then the advertiser may not wish to bid on any ad inventories containing ad spaces to be presented to male visitors. An advertiser may also wish to only advertise with certain publishers (e.g., Yahoo!). In this case, the advertiser is unlikely to select any available ad inventories owned by other publishers (e.g., Google). An advertiser may wish to place its advertisements only in ad spaces presented within a certain geographical area (e.g., California) or during certain time periods (e.g., during day time on weekends) and thus may only wish to bid on those ad inventories that satisfy its digital campaign criteria. These criteria may be reflected in the various desired features specified for the ad orders of the advertiser.

In particular embodiments, when an ad inventory becomes available, the desired features of each of the ad orders may be compared to the ad space and the visitor of the available ad inventory. If there is sufficient similarly between the desired features of an ad order and the ad space and the visitor of the available ad inventory, or if the ad space and the visitor of the available ad inventory satisfy the desired features of an ad order, particular embodiments consider the available ad inventory as a suitable match to the ad order. Note that it is possible that multiple ad orders of the same advertiser or multiple ad orders of multiple advertisers may match an available ad inventory at the same time. Using the above example, if the visitor of the available ad inventory is a male, then it may not be deemed suitable to an ad order specifically targeting female visitors. Conversely, if the visitor of the available ad inventory is a female, then it may be deemed suitable to the ad order. If the ad space of the available ad inventory is to be presented at 10:00 pm on a Monday, then it may not be deemed suitable to the ad order specifically targeting ad spaces presented during day time on weekends. Conversely, if the ad space of the available ad inventory is to be presented at 10:00 am on a Saturday, then it may be deemed suitable to the ad order.

In another example, if the ad-space in the ad inventory is contained in a webpage constructed to present the search result identified in response to a search query “Napa wineries” and the keywords contained in an ad order include “red wine,” “white wine,” “Pinot Noir,” “Chardonnay,” or “Cabernet Sauvignon,” then the ad inventory may be suitable for the ad order because the content of the advertisement contained in the ad order is related to the search query that causes the webpage containing the ad space to be constructed. If the webpage containing the ad space is to be presented to a visitor located in California and the desired visitor features in an ad order indicate that the ad space should be presented to visitors physically located in California, then the ad inventory may be suitable for the ad order because the desired ad-space features in the ad order are similar to the actual ad-space features in the ad inventory. Conversely, if the ad space should be presented to visitors located on the East Coast of the United States, then the ad inventory may not be suitable for the ad order.

In particular embodiments, the publisher owning the available ad inventory or the ad exchange representing the publisher owning the available ad inventory may inform the appropriate parties managing those ad orders that are considered to match the available ad inventory of the available ad inventory and call for bids on the available ad inventory. Conversely, advertisers that do not have any ad order for which the ad inventory may be suitable may not be notified of the ad inventory. Note that multiple ad inventories owned by a publisher may be available at any given time. In the case where the publisher employs an ad exchange, the publisher may notify the ad exchange of all of its available ad inventories at any given time, and the ad exchange may in turn call for bids on each of the available ad inventories on behalf of the publisher. If the publisher manages its own ad inventories, the publisher may call for bids on each of its available ad inventories directly. As an example and not by way of limitation, a cost-per-impression bid is the maximum amount of money an advertiser is willing to pay for placing one of its advertisements in an ad space of an ad inventory. Other typical bid models include cost-per-mille, cost-per-click, and cost-per-action.

Upon receiving information concerning an available ad inventory matched to a particular ad order, particular embodiments may determine a bid price for the ad inventory. For the purpose of clarification, hereafter, the available ad inventory matched to a particular ad order is referred to as “the current ad inventory” and the associated ad order is referred to as “the current ad order” because they are the ad inventory and ad order that the digital-marketing platform is currently processing. Similarly, the ad space contained in the current ad inventory is referred to as “the current ad space.” The visitor associated with the current ad inventory and to whom the current ad space is to be presented is referred to as “the current visitor.” The user intent of the current visitor is referred to as “the current user intent.” The advertisement of the current ad order is referred to as “the current advertisement.” The publisher or the ad exchange selling the current ad inventory is referred to as “the current seller.” And the advertiser or the broker managing the current ad order and bidding on the current ad inventory is referred to as “the current buyer.”

Advertisers typically attempt to improve the volume and return-on-investment of their search-engine-marketing campaigns. However, advertisers can face numerous problems and challenges.

Advertisers may face challenges in managing ad inventories and placing appropriate ad orders. As an example and not by way of limitation, an advertiser may have difficulty anticipating possible search engine queries and selecting appropriate keywords to bid on. Users can enter nearly any query into a search engine, which means that the list of keywords a marketer can bid on may be enormous. However, in practice, there are limits on the number of keywords on which advertisers can bid. Advertisers may not have the capacity to manage such enormous numbers of keywords. Furthermore, search publishers may set limits on the number of keywords an advertiser can have in its account; and not all keywords will be relevant or profitable for a given advertiser. Given the vast number of potential keywords, it may be a challenge for advertisers to systematically anticipate and select keywords that will achieve their marketing objectives, such as, for example, driving the highest volume and quality of clicks with the least amount of cost.

Once keywords are selected, the advertiser may want to maximize campaign performance by systematically and consistently grouping the selected keywords. Text ads or ad copy are typically not assigned to individual keywords. Rather, they are assigned to groups of keywords, called ad groups. As such, how keywords are grouped is important because ad groups determine which ad can be shown once the keyword is matched to a query, which in turn impacts volume, conversion, and return-on-investment.

Once ad groups are created, the advertiser may assign ad copy to each ad group. To improve conversion, the advertiser will typically attempt to make the text ads as relevant as possible to all the keywords in the ad group. The advertiser may, for example, review each ad group and manually write relevant ad copy for each group. However, by using this approach it may be challenging for the advertiser to consistently determine the relevance between ad copies and ad groups. Furthermore, this approach may present challenges in scalably optimizing the relevance of ad copies across a large campaign with numerous ad groups.

Once ad copy is assigned to each ad group, an advertiser may assign a click-through URL or landing page to the ad copy or to the keyword. To improve conversion, the advertiser may make the URL or landing page as relevant as possible to the keyword matched to the query and to the ad copy displayed to or clicked on by the user. However it may be challenging and time consuming for advertisers to create highly relevant landing pages for each keyword or ad copy combination or to choose the most relevant landing page from among an existing set of landing pages for each keyword/ad copy combination. This may be achieved, for example, by using product facets on the advertiser's website or by directing the user to a search results page where the search is performed using the keyword or query or related user information.

Next, an advertiser may place a bid (typically on a cost-per-click basis) on a keyword. However, if the advertiser has never bid on a keyword or shown a given keyword/ad copy/landing page combination, the advertiser may not have an accurate idea of an appropriate cost-per-click bid on the keyword. The advertiser may choose an arbitrary cost-per-click, but if the cost-per-click bid is too low, the keyword may not be displayed by the search engine and consequently may never receive any clicks. In contrast, if the cost-per-click bid is too high, the advertiser may lose a significant amount of money on the keyword before the bid can be adjusted. As such, advertisers may desire to leverage prior campaign-performance data to better estimate appropriate cost-per-click bids for keyword/ad copy/landing page combinations that have little or no performance history associated with them.

Once bids are placed on keywords, an advertiser may attempt to optimize their campaign on an ongoing basis. For example, the performance data of deployed keywords may be used to improve the selection of additional keywords. As another example, ad groups may be revised and new ad groups may be formed in response to performance data. Similarly, ad copies and landing pages may be revised based on performance data. For example, the same ad copy may perform well for one ad group and poorly for another ad group, and performance data may be used to predict which ad copy will work well for a given ad group. As another example, some elements of a landing page may perform well for one ad group and poorly for another ad group, and performance data may be used to predict which landing page elements will work well for a given ad group. Performance data may also be used to optimize bids on keywords. For example, performance data could be used to “pause” bids on certain keywords (for example, by setting a bid to zero). As another example, performance data could be used to identify negative keywords, which are keywords that, if included in a query, indicate that an ad inventory should not be matched to the ad order, even if other elements of the query match closely to the other elements of the keyword. However, optimizing any of these campaign elements may be challenging because of the lack of data for determining statistically significant trends. As such, it may be challenging for advertisers to optimize bids, keyword selection, ad copy, ad groups, landing pages, or other campaign elements due to a lack of statistically significant data. And advertisers may find it undesirable to wait for time to pass so that more data can be collected.

Most search engines (e.g., Google) employ a concept similar to the quality score metric. A quality score is intended to reflect the search engine's perception of how relevant a user whose query is matched to an advertiser's keyword will find the advertiser's landing page to the query and/or the advertiser's displayed ad copy. The search engine apparently uses the quality score to promote ads that it believes will lead to a more relevant user experience. The search engine automatically assigns a quality score to each keyword, and, if a quality score is low, the corresponding ad can appear very far down a search results page (or, even worse, the keyword can be automatically deactivated by the search engine). However, the assignment of quality scores by a search engine may be inconsistent, making it a challenge for advertisers to predict the quality score for any keyword/ad copy/landing page combination. Low quality scores or declines in quality scores may adversely affect an advertiser's campaign by lowering volume, conversion, and consequently lowering the return-on-investment on the campaign. Thus, a challenge for these advertisers is how to systematically improve or maintain the quality scores of their keywords.

### Search Intent Marketing

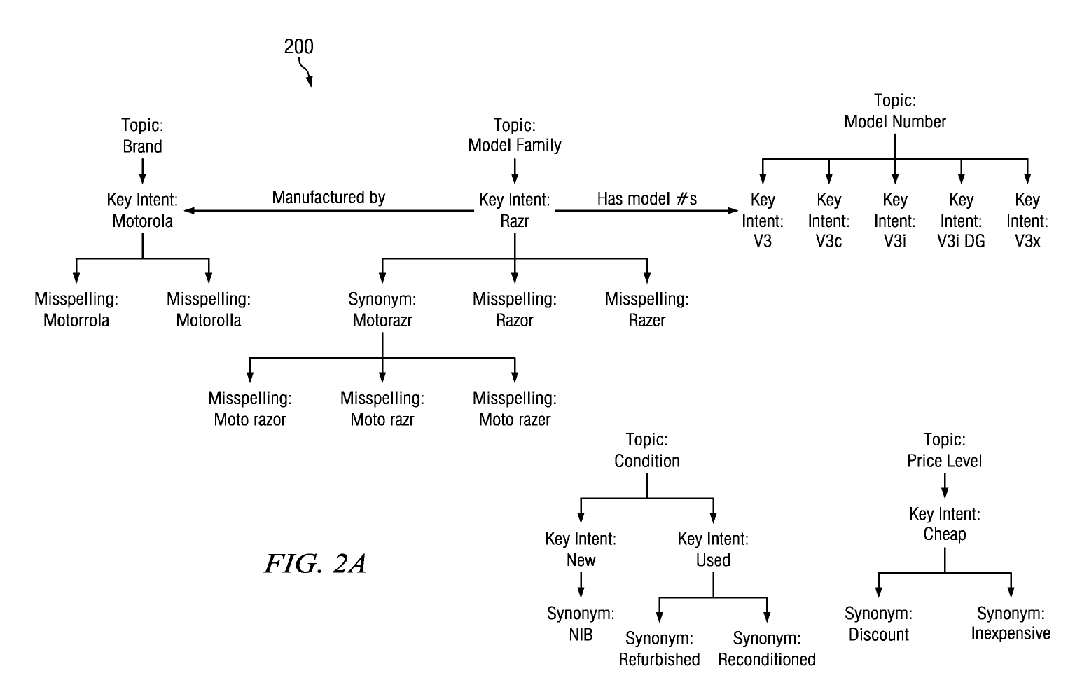

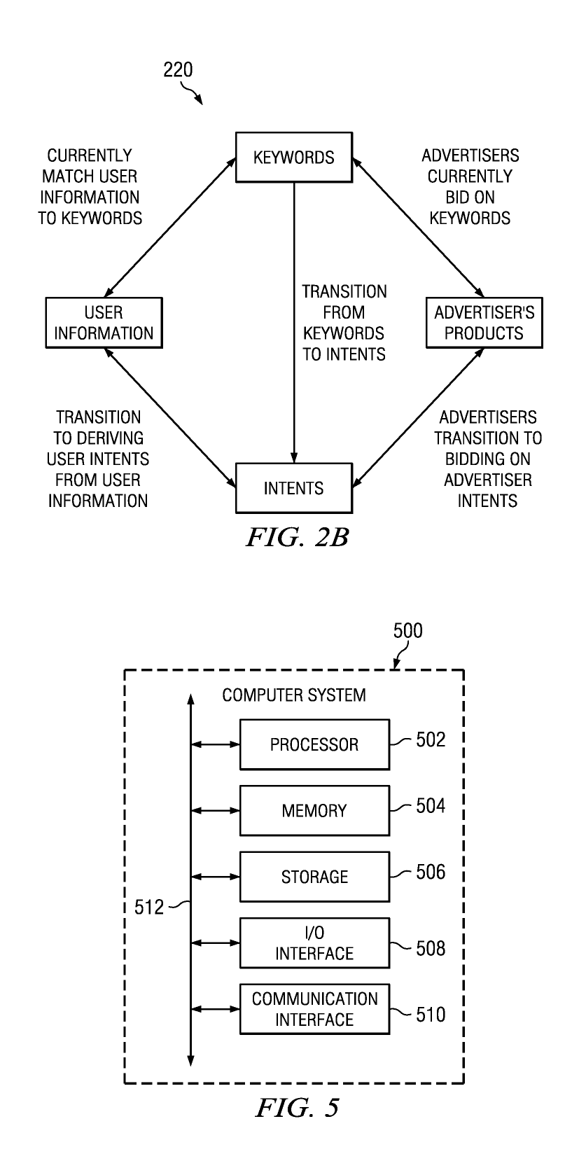

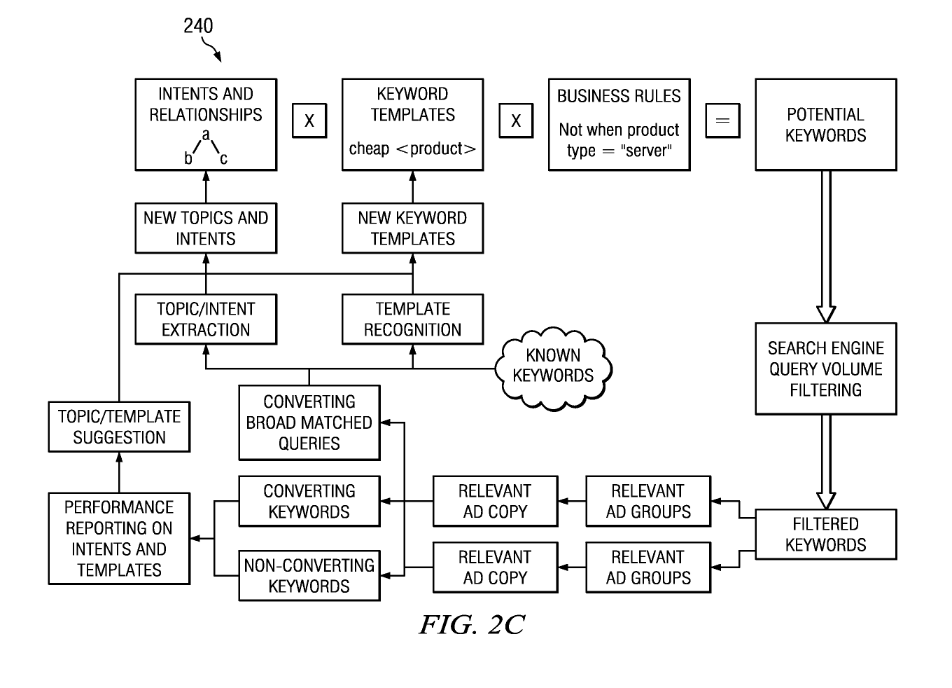

FIG. 2A illustrates an example intent map 200. In particular embodiments, a particular intent map may be associated with a particular category of products. The intent map illustrated in FIG. 2A is associated with the mobile phone product category. The intent map has five intent topics: <brand>, <model family>, <model number>, <condition>, and <price level>. The intent topic <brand> includes the key intent <brand=Motorola>. The key intent <brand=Motorola> may match with the user intent “Motorola,” or with user intents representing misspellings of that key intent, such as “Motorrola” or “Motorolla.” The intent topic <model family> includes the key intent <model family=Razr>, where a “Razr” is a brand of cell phone manufactured by the company Motorola. The key intent <model family=Razr> may match with the user intent “Razr,” or with user intent that represent misspellings of that key intent, such as “Razor” or “Razer.” Similarly, the key intent <model family=Razr> may match with the keyword “Motorazr,” which is a synonym of “Razr,” and that synonym may match with misspellings of the synonym, such as “Moto razor,” “Moto razr,” or “Moto razer.” The intent topic <model number> includes the key intents <model number=V3, V3c, V3i, V3i DG, V3x>. The key intents <brand=Motorola> and <model family=Razr> are related to each other, where the former key intent has the relationship of “manufactured by” with respect to the latter key intent. Furthermore, the key intents <brand=Motorola> and <model number=V3, V3c, V3i, V3i DG, V3x> are related to each other, where the former key intent has the relationship of “has model numbers” with respect to the latter key intents. The intent map also includes the intent topics <condition> and <price level>. The intent topic <condition> contains the key intents <condition=new> and <condition=used>. The key intent <condition=new> may match with the user intent “new” or with the synonym “NIB.” The key intent <condition=used> may match with the user intent “used” or with the synonyms “refurbished” or “reconditioned.” Finally, the intent topic <price level> includes the key intent <cheap>, which may match with the user intent “cheap” or with user intents that represent synonyms of that user intent, such as “discount” or “inexpensive.” Although this disclosure describes a particular intent map with particular elements, this disclosure contemplates any suitable intent maps with any suitable elements. For example, although this disclosure describes particular intent topics, this disclosure contemplates intent maps with any suitable intent topics.

FIG. 2B illustrates a schematic 220 of the relationships between user information, keywords, intents, and products. Currently, advertisers may bid on keywords that they believe users will enter into search queries, where the advertisers assume that particular keywords (such as, for example, products brands and models) will be used in a search for particular products. In contrast, in particular embodiments, an intent-marketing platform functions by deriving user intents from user information, which may also include keywords from search queries. The intent-marketing platform may look at search queries by a user and other explicit and implicit user information to determine the user intent behind a search query. And advertisers, rather than bidding on keywords, may bid on advertiser intents that may match up with user intent of a search query. The intent-marketing platform may then align user intents with advertiser intents. Where the intents match, the intent-marketing platform may then match the products associated with the advertiser intents to the user. Although this disclosure describes particular relationships between user information, keywords, intents, and products, this disclosure contemplates any suitable relationships between user information, keywords, intents, and products.

In particular embodiments, a search-engine-marketing platform may function as an intent marketplace, which is an exchange-based online marketplace where publishers may make available opportunities to advertise to users and where users may be described by their underlying intent (i.e., user intent). As used herein, the term “intent” may mean either an individual instance of a topic (such as, for example, topic=brand, intent=Puma) or a vector of individual instances of topics (such as, for example, <brand=Nike>, <color=white>), unless context suggests otherwise. Furthermore, as used herein, this disclosure may use a shorthand to allow reference to multiple intent vectors, such as, for example, <brand=Nike, Reebok, Adidas>, <color=all> refers to <brand=Nike>, <color=white>, <brand=Reebok>, <color=orange>, <brand=Adidas>, <color=black>, etc. In the intent marketplace, advertisers may bid on opportunities to advertise to users (such as, for example, with standing orders (i.e., lines) or real-time bids). Bids may include advertiser intents that the advertiser wants to advertise to (these can then be matched to user intents), denomination of payment (such as, for example, cost-per-impression, cost-per-click, or cost-per-action), and the price the advertiser is willing to pay. User intent describes what a particular user's objective is, and it may be derived or predicted from explicit or implicit user information. The intent marketplace may then decide which advertiser line to match with a particular advertising opportunity based on the fit between the user intent associated in the advertising opportunity and the advertiser intent, which is based on the advertiser's intent-based lines. The marketplace may also decide which advertiser line to match with a particular advertising opportunity based on the maximum estimated compensation for the publisher, which may be estimated on a cost-per-impression or estimated cost-per-mille basis. The marketplace may determine a clearing price for a particular line for impression- and click-based bids. If compensation is action-based, the marketplace may track whether the action took place and charge the advertiser appropriately. The intent marketplace may span multiple channels, including paid search, mobile, and display. As such, for a particular line, there may be ads of multiple formats associated with the line (such as, for example, a paid search ad, a banner ad, and a mobile ad). The intent marketplace may also support both standing lines and real-time bid functionality. Although this disclosure describes an intent marketplace functioning in a particular manner, this disclosure contemplates an intent marketplace functioning in any suitable manner.

In particular embodiments, an advertiser may use a web-based interface or an Application Programming Interface (API) that allows the advertiser to submit an intent-based line to a publisher. The advertiser may give the line a human-readable name and each line may have a unique identification (ID) associated with it. If the line is changed, the unique ID may also change, and the previous line ID may be deactivated. Similarly, lines may be deactivated and remain in the system to be reactivated. The search publisher may want the ability to review ads received by the intent marketplace, so that, for example, the publisher can determine whether an ad meets the publisher's guidelines. The intent marketplace may allow a search publisher to transmit topic/intent name-value pairs (i.e., a pair consisting of the topic name and the intent value, where the intent value is one of the intents in the specific intent topic) to the intent marketplace. In particular embodiments, a line consists of one or more user intents the advertiser would like to advertise to. Advertiser may place one or more bids on one or more specific advertiser intents from a plurality of advertiser intents. Each bid may comprise an advertiser intent, an advertisement, a condition, and a maximum payment amount that an advertiser placing the bid agrees to pay when the condition is satisfied. As an example and not by way of limitation, a combination of intent topics that an advertiser may bid on may be <shoes>, or <brand> <shoes>, or <color> <brand> <shoes>. The line may be constrained to certain advertiser intents. As an example and not by way of limitation, a line may be constrained to specific brands with the construction <brand=Nike, Adidas, Reebok> <shoes>. Similarly, certain advertiser intents may be excluded from lines. As an example and not by way of limitation, a line may exclude a certain brand with the construction <brand!=Puma>. The sequence of intent topics in a line may or may not have significance, such that a particular ordering of intent topics may be significant in particular embodiments. In particular embodiments, the advertiser may specify that the line should exclude particular intent topics. As an example and not by way of limitation, for the line <brand> <shoes>, the query “green Nike shoes” could be excluded because it includes the user intent <color=green>, and the <color> intent topic is not included in the line. In this case, the query would not be matched with the line <brand> <shoes> because it includes an intent outside of the scope of the intents specified in the line. In particular embodiments, an advertiser may choose to specify the channel associated with a line, such as, for example, paid search, mobile, display, another suitable channel, or two or more such channels. If the channel specified is display, the advertiser may also specify the size of the banner ad. For each associated channel, a line may have one or more ads associated with the line. For paid search, a paid search text ad may include, for example a headline/title, one or more lines of ad description, a display URL, and a click-through URL. For a display ad, the ad may include, for example, a banner ad and a click-through URL. Multiple banner ads may be associated with a display line since there are multiple sizes for banner ads. For a mobile ad, the ad may include, for example, a mobile ad and a click-through URL. Ads may be stored as separate entities from the line, so that any line may be associated with any ad that is suitable for a particular channel. The intent marketplace may include an ad creation tool that enables an advertiser to create intent-based ad templates. An ad template may be associated with a line if the intent topics contained in the line are also contained in the template. In particular embodiments, an advertiser may choose to specify one or more publishers associated with a line, such as, for example, by selecting from a list of publishers in the system. There may be some publishers that participate on a blind/anonymous basis, and other publishers that participate on a non-blind basis. Although this disclosure describes an intent marketplace receiving bids in a particular manner, this disclosure contemplates an intent marketplace receiving bids in any suitable manner.

In particular embodiments, a bid placed by an advertiser on a specific advertiser intent may include a condition and a maximum payment amount that an advertiser placing the bid agrees to pay when the condition is satisfied. An advertiser line may specify a pricing model for the line. As an example and not by way of limitation, a line may specify cost-per-impression, cost-per-click, cost-per-action, or another suitable pricing model. For a cost-per-action condition, the condition is satisfied when a user completes a transaction subsequent to interacting with an advertisement displayed to that user, wherein the advertisement is associated with a cost-per-action bid. If the line specifies a cost-per-action pricing model, the advertiser may display a conversion pixel on their website to track when an action (such as, for example, a conversion) that triggers payment occurs. For a cost-per-click condition, the condition is satisfied when a user interacts with an advertisement displayed to that user, wherein the advertisement is associated with a cost-per-click bid. For a cost-per-impression condition, the condition is satisfied when a specific advertisement is matched to a user and displayed to the user. A cost-per-impression line may have a frequency cap associated with it, such that only a predetermined number of impressions is shown over a specified time for any given user or group of users. In particular embodiments, a line may specify a maximum allowable price, a total allowable budget, or a daily allowable budget. A line that has reached its total allowable budget may be automatically deactivated. Similarly, a line that has reached its daily allowable budget may be temporarily deactivated, or it may remain active but simply not be considered by the intent marketplace for matching for the rest of the day. A line may contain a start and end time/date. If a line is inactive, it may automatically become active when the start date/time is reached. Similarly, if the line is active, it may automatically be deactivated when the end date/time is reached. In particular embodiments, a line will have a click-through-rate history or conversion-rate history associated with it, allowing for estimated cost-per-impression or estimated cost-per-mille calculations. Although this disclosure describes bids with particular conditions, this disclosure contemplates bids with any suitable conditions.

In particular embodiments, the intent marketplace may match advertiser lines with available ad space. The intent marketplace may select, from a plurality of advertiser intents, one or more advertiser intents that align with one or more user intents. The intent marketplace may then match one or more of a plurality of products (which align with one or more advertiser intents) with the one or more user intents that are identified with a user. As an example and not by way of limitation, the intent marketplace may match advertiser lines with available ad space based on the user intent of a visitor who will view that ad space, the user intents of the publisher's available ad space (based on the primary and secondary intents), the advertiser intents specified in the advertiser lines (including whether other intents or particular intents should be excluded), other suitable factors, or two or more such factors. The intent marketplace must then order or rank matching advertiser lines. As another example and not by way of limitation, the intent marketplace may match advertiser lines with available ad space by first deriving a plurality of keywords from the plurality of advertiser intents. The intent marketplace may reference the intent graph or a particular intent map to determine which keywords correspond to which advertiser intents. For example, if the advertiser intent is <model family=Razr>, then keywords that match this advertiser intent may include “Razr,” “Motorazr,” “Razor,” “Razer,” or “Moto razor.” The intent marketplace may then match one or more of the plurality of keywords with one or more user intents. For example, the keyword “Razr” may match with the user intent <model family=Razr>. The intent marketplace may then select one or more of the plurality of advertiser intent from which the one or more of the plurality of keywords are derived. For example, if the keyword “Razr” is derived from the advertiser intent <model family=Razr>, the intent marketplace may then select the advertiser intent <model family=Razr>. Based on the selected advertiser intent, the intent marketplace may then select an advertiser line that matches that advertiser intent. In particular embodiments, the intent marketplace may consider other factors when matching advertiser lines with available ad space, such as the predicted click-through-rate for an ad, the predicted cost-per-mille for an ad, the likelihood of a combination of derived user intents matching the actual user's intent, or other factors. The intent marketplace may predict the click-through-rate for an advertiser line based on the history associated with the line. Or, if no history is associated with the line, then based on the history associated with the advertiser associated with the line or the system average history click-through-rate. Similarly, the intent marketplace may predict the conversion rate for an advertiser line based on the history associated with the line. The intent marketplace may then estimate a cost-per-mille, where the cost-per-mille is equal to the predicted click-through-rate multiplied by the cost-per-click for cost-per-click based orders, or equal to the predicted click-through-rate multiplied by the predicted conversion rate times the cost-per-action for cost-per-action based orders. Cost-per-action based lines may be tracked using conversion pixels to track when the action specified in the line takes place so that an advertiser may be charged appropriately. Also, if there were multiple user intents associated with a particular user, the intent marketplace may consider the likelihood of a particular user intent combination (i.e., whether it is a primary or secondary intent) when matching lines to available ad space. Once an advertiser intent has been aligned to a user intent, the intent marketplace may then advertise to the user based on the advertiser intent that aligns with the user intent. As an example and not by way of limitation, the intent marketplace may select an advertiser line corresponding to the advertiser intent and recommend one or more products to the user. As another example and not by way of limitation, the intent marketplace may select from the bids on specific advertiser intent a bid placed on the one or more advertiser intents that align with the one or more user intents. The intent marketplace may send or present one or more advertisements of the recommended products to a client system or other electronic device associated with the user for presentation to the user. Although this disclosure describes matching advertiser lines with available ad space in a particular manner, this disclosure contemplates matching advertiser lines with available ad space in any suitable manner.

In particular embodiments, the intent marketplace may provide performance reports to advertisers or publishers, allowing them to see the performance for a particular line, for a particular advertisement, or for a particular marketing campaign. A performance report may show, for example, the number of impression, the number of clicks, the click-through-rate, the cost-per-click, the number of conversions, the conversion rate, the cost-per-action, or other suitable performance information associated with the line. The intent marketplace may also provide intent-based performance reports that allow advertisers to filter or aggregate lines based on one or more intents. As an example and not by way of limitation, a performance report may allow an advertiser to filter reports on lines to show the performance of lines with the intents <color=red> and <brand=Nike>. Performance reports for advertisers may be in aggregate, by line, by creative, or by intent combinations. Performance reports for publishers may be in aggregate, by URL, or by intent combination. Although this disclosure describes an intent marketplace providing particular reports in a particular manner, this disclosure contemplates an intent marketplace that provides any suitable reports in any suitable manner.

In particular embodiments, the intent marketplace may include an intent graph. An intent graph is a list of all intent topics and user intents represented in the intent marketplace. The intent marketplace may maintain version control on the intent graph, with prior versions of the intent graph stored and the ability to roll back to prior versions of the intent graph. The intent marketplace may provide a user interface or API that allows system administrators or other users to update the intent graph. When the intent graph is updated (such as, for example, an intent topic is renamed, or an intent is moved to a new intent topic), the intent marketplace may automatically update existing lines to refer to the updated version of the intent graph. Although this disclosure describes an intent graph with particular features, this disclosure contemplates an intent graph with any suitable features.

In particular embodiments, the intent marketplace may derive user intents based at least in part on search queries from users. The intent marketplace may receive one or more user's search queries from a publisher. Once a search query is transmitted to the intent marketplace, the intent marketplace may analyze the search query to determine the user intent of the query. In particular embodiments, the intent marketplace may parse a query submitted by a user to determine one or more words or one or more words set of words. As an example and not by way of limitation, the intent marketplace may parse a search query for all n-grams. In general, an n-gram is a sub-sequence of n items from a given sequence. An n-gram of size 1 is referred to as a “unigram,” of size 2 is referred to as a “bigram” or “digram,” and of size 3 is referred to as a “trigram.” In particular embodiments, a search query n-gram includes each segment of the query. Due to the different combinations, there may be many search query n-grams constructed from the search query segments obtained from a search query. As an example and not by way of limitation, the search query “big apple taxis” includes the segments “big,” “apple,” and “taxis.” From this search query, the intent marketplace may construct the following n-grams: (big), (apple), (taxis), (big apple), (apple taxis), (big taxis), (big apple taxis). In particular embodiments, after parsing a query, the intent marketplace may determine one or more intents included in a query based on the one or more words or the one or more sets of words. As an example and not by way of limitation, once the intent marketplace has identified the possible n-grams, it may then determine which n-grams match with intents that are present in the intent marketplace. This may be done by referencing an intent graph or a collection of intent maps which may be stored by the intent marketplace. For the query “big apple taxis,” an intent graph may contain the intents:

the n-gram (big) matches with the intent <size=big>,
the n-gram (apple) matches with the intents <fruit=apple> and <brand=Apple>,
the n-gram (taxis) matches with the intent <car type=taxi>, and
the n-gram (big apple) matches with the intent <city=New York>.
The n-grams (apple taxis), (big taxis), and (big apple taxis) may not match with any intents in the intent graph. After identifying which n-grams are present in the intent graph, the intent marketplace may analyze the various combinations of these intents to determine the user intent, i.e., the intent of the query. As an example and not by way of limitation, for the query “big apple taxis,” the intent marketplace may determine the following possible user intent combinations: <size=big, fruit=apple, car type=taxi> or <city=New York, car type=taxi>. The intent marketplace may then determine which possible combination of user intents is most likely, which is called the primary intent, and which possible combinations of user intents are less likely, which are called secondary intents, to match with the actual user intent of the search query. There may be one or more secondary intents, and they may or may not be rank ordered based on likelihood. As an example and not by way of limitation, for the query “big apple taxis,” the intent marketplace may determine that the user intent combination <city=New York, car type=taxi> is a more likely and is therefore the primary intent and that the user intent combination <size=big, fruit=apple, car type=taxi> is less likely and is therefore a secondary intent. Once the most likely user intent combinations are determined, the intent marketplace may then match lines from advertisers with the user intent combinations. Lines that match primary intent combinations may be given priority over lines that match secondary intent combinations. Although this disclosure describes deriving user intent from search queries in a particular manner, this disclosure contemplates deriving user intent from search queries in any suitable manner. Moreover, although this disclosure describes deriving particular user intents from particular search queries, this disclosure contemplates deriving any suitable user intents from any suitable search queries.

In particular embodiments, the intent marketplace may derive user intents from user information associated with a user. As discussed above, the intent marketplace may derive user intents from search queries from a user. Furthermore, the intent marketplace may derive user intent from explicit or implicit user information. As an example and not by way of limitation, if the intent marketplace knows the user's present location is 1001 East Hillsdale Blvd, Foster City, Calif., then the intent marketplace may be able to determine the following possible user intents: <city=Foster City>, <county=San Mateo>, <state=California>, <country=United States>, <continent=North America>. In particular embodiments, search queries may be used in conjunction with other explicit or implicit user information to determine the user intent associated with a user's search query. As an example and not by way of limitation, for the query “apple hiring,” the possible user intents may be <fruit=apple>, <employer=Apple>, <call to action=hiring>, and the possible user intent combinations may be <fruit=apple, call to action=hiring> and <employer=Apple, call to action=hiring>. For a user with a present location of <county=San Mateo, state=California>, the <employer=Apple, call to action=hiring> may be a more likely user intent combination because the company Apple, Inc. is headquartered in Santa Clara County, California, which is adjacent to San Mateo County. In contrast, for a user with a present location of <county=Chelan, state=Washington>, the <fruit=apple, call to action=hiring> may be a more likely user intent combination because apple farming is a major industry in Chelan County, Washington. Although this disclosure describes deriving particular intents from particular user information, this disclosure contemplates deriving any suitable intents from any suitable user information. Moreover, although this disclosure describes deriving user intent from user information in a particular manner, this disclosure contemplates deriving user intent from user information in any suitable manner.

In particular embodiments, the intent marketplace may derive one or more user intents of a user visiting an advertising publisher's webpage or website by analyzing a webpage or website associated with an advertising publisher to determine an intent associated with the user. As an example and not by way of limitation, the intent marketplace may derive user intents by crawling a publisher's website or a particular webpage within a publisher's website to identify n-grams. An advertiser's website may be crawled in advance (pre-crawling) or in real-time (such as for dynamic webpages). A visitor to a publisher's website may have their user intent derived at least in part based on the content of the publisher's website. The intent marketplace may crawl an advertiser's website, identify all the words or terms on the website, and construct a set of n-grams for the website. The intent marketplace may crawl an advertiser's website at any suitable time, such as, for example, times specified by the advertiser, times specified by the intent marketplace, periodically, when the website has been modified, at another suitable time, or at two ore more such times. The intent marketplace may then determine, based on the constructed n-grams, which intents from an intent graph are present in the advertiser's website. The intent marketplace may prune or aggregate n-grams to a canonical of a set of intents (such that synonyms and misspellings are counted as the canonical) in the intent graph to determine the frequency of the canonicals in the website. The intent marketplace may then select one or more intents that appear on a particular website and define those intents to be user intents associated with the website. Visitors to that website (or a webpage within that website) may then be assumed to have a user intent matching the user intent derived by the intent marketplace. Advertiser lines that match the user intent may then be presented to the visitor. The publisher may receive the ad, or the ad may be served directly to the visitor's client system or browser. The publisher may have specified the type of ad that should be served (such as, for example, text, display, mobile), the size of ad that should be served, and the number of ads needed. In particular embodiments, the intent marketplace may tag or label each page or section of the publisher's website with the derived user intents. The URL and the derived user intents may be cached for use when another user visits the same website or webpage. Although this disclosure describes deriving user intent from a publisher's website in a particular manner, this disclosure contemplates deriving user intent from a publisher's website in any suitable manner.

In particular embodiments, the intent marketplace may identify n-grams based at least in part on term-frequency-inverse-document-frequency (tf-idf) of one or more words (or terms) in a publisher's website. The tf-idf is a statistical measure used to evaluate how important a word is to a document in a collection or corpus. The importance increases proportionally to the number of times a word appears in a particular document, but is offset by the frequency of the word in the corpus of documents. The term count in a document is simply the number of times a given term appears in the document. This count may be normalized to prevent a bias towards longer documents (which may have a higher term count regardless of the actual importance of that term in the document) and to give a measure of the importance of the term i within the particular document j. Thus we have the term frequency tf_{i,j}, defined in the simplest case as the occurrence count of a term in a document. The inverse-document frequency (idfᵢ) is a measure of the general importance of the term i which is obtained by dividing the total number of documents by the number of documents containing the term, and then taking the logarithm of that quotient. A high weight in tf-idf is reached by a high term frequency in the given document and a low document frequency of the term in the whole collection of documents; the weights hence tend to filter out common terms.

In particular embodiments, the intent marketplace may generate a set of n-grams based at least in part on term-frequency-inverse-document-frequency (tf-idf). The following is an example algorithm that an intent marketplace could use to calculate a tf-idf value for a particular website:

(tf−idf)_{i,j}=tf_{i,j}×idfᵢ

where:

$${tf}_{i , j} = \frac{{n}_{i , j}}{{\sum }_{s ∈ T} {n}_{s , j}} , and {idf}_{i} = log \frac{\vert D \vert}{\vert \{ j ∈ D \text{:} i ∈ j \} \vert}$$

and where:
(tf−idf)_{i,j} is the term-frequency-inverse-document-frequency for the term i in document j,
tf_{i,j} is the term frequency of term i in document j,
idfᵢ is the inverse document frequency of term i,
n_{i,j} is the number of times term i appears in document j,
T is the set of all terms present in the document corpus, and
D is the set of all documents in the corpus.
   Although this disclosure describes identifying n-grams using a particular algorithm, this disclosure contemplates identifying n-grams using any suitable algorithm. Moreover, although this disclosure describes identifying n-grams using particular variables that represent particular information, this disclosure contemplates identifying n-grams using any suitable variables representing any suitable information.

In particular embodiments, an advertiser may utilize an intent-marketing platform, which may be a suite of software-as-a-service products. The intent-marketing platform may be used in isolation or may be used in conjunction with an intent marketplace to help advertisers utilize the intent marketplace. The intent-marketing platform may help advertisers improve the effectiveness of their marketing campaigns, such as, for example, a search-engine-marketing campaign. As an example and not by way of limitation, the intent-marketing platform may increase the relevance of ad copy/landing page combinations, allowing advertisers to improve the volume and the return-on-investment of their campaigns. In one embodiment, an intent-marketing platform may interface with a search-engine-marketing platform or an intent marketplace. In another embodiment, an intent-marketing platform may be integrated, in whole or in part, with a search-engine-marketing platform or an intent marketplace. In yet another embodiment, a intent-marketing platform may replace or substitute for a search-engine-marketing platform or an intent marketplace. In particular embodiments, the intent-marketing platform may be a web-based software-as-a-service, where the customer account could be created on the intent-marketing platform, and the customer (i.e., advertiser) would be given an ID and password to access the account. In particular embodiments, the intent-marketing platform can be a managed service, where a service provider can operate the intent-marketing software on behalf of the customer. Although this disclosure describes implementing the intent-marketing platform in a particular manner, this disclosure contemplates implementing the intent-marketing platform in any suitable manner.

In particular embodiments, the intent-marketing platform may comprise one or more intent maps. An intent map may be used to identity a plurality of advertiser intents for a plurality of products. The plurality of products may or may not belong to the same business or industry. In particular embodiments, an intent-marketing platform may construct an intent map for a plurality of products. The intent map may comprise one or more intent topics, and each intent topic may comprise one or more intents. Each intent in an intent map can be a member of one intent topic. However, because some words are polysemous or have different senses, the same word can show up in more than one intent topic, but these may be considered different intents because of the distinct meaning or sense. Intent map functionality is based on intent topics, intents, and relationships defined and maintained within the intent maps. An intent map may enable an advertiser to discern the underlying user intent from user information associate with the user. In particular embodiments, an intent map may comprise a graph of words and labels. The words represent intents, such as, for example, that a user might enter as part of a query into a search engine, such as, for example, a publisher 120. In particular embodiments, an intent may be any word or phrase that can be used within a keyword expression. The labels (also referred to as “intent topics”) represent categories or groups of intents. An intent topic may be a logical grouping of related terms in an industry (also referred to as a “vertical”). However, some topics may not be vertical specific, such as purchase intents (for example, <buy>, <purchase>, <sign up>). In particular embodiments, the intent topics in an intent map may form one or more hierarchies. A hierarchy of intent topics may comprise a set of intent topics and a plurality of levels, wherein each level includes at least one intent topic. In particular embodiments, intent topics may be grouped into one or more intent-topic categories. Intent-topic categories may include, for example, product categories (such as, for example, <phones>, <home furnishing>), products (such as, for example, <smart phones>, <chairs>), general product descriptions (such as, for example, <color>, <size>, <price>, <condition>), specific product descriptions (such as, for example, <manufacturer>, <model number>), calls to action (such as, for example, <purchase>, <compare>, <reviews>), or call-to-action descriptions (such as, for example, <store>, <online>, <discount>). Each intent topic of an intent map or an intent graph may belong to or relate to one or more intent-topic categories. Where there is a hierarchy of intent topics, one or more of the intent topics in the hierarchy may belong to a common intent-topic category. In particular embodiments, there may be one or more topic relationships (also referred to as “relationships”) among one or more intent topics or among one or more intents of the intent topics. Links in the intent map graph represent relationships between intents, between intent topics, and between intents and intent topics. Within an intent topic, relationships between pairs of intents, such as “is a synonym of,” “is a misspelling of,” and “is a plural of,” may be defined. As an example and not by way of limitation, the intent <product=iPod> may have a relationship of have a plural of <product=iPods>. In particular embodiments, the effect of defining these relationships is to divide all the intents within an intent topic into connected components. Within each such component, one intent may be chosen to be a “key intent.” A link may be added to the intent map graph between each key intent and its corresponding intent topic. Thus, within an intent topic, each intent may either be a key intent (in which case it is directly connected to the intent topic) or be connected to a key intent (either directly, such as being a misspelling of the key intent, or indirectly, such as being a plural of a synonym of the key intent). Although this disclosure describes intent maps with particular structures and particular relationships, this disclosure contemplates intent maps with any suitable structures and any suitable relationships.

In particular embodiments, an intent-marketing platform may access user information associated with a user. User information may include, for example, explicit user information associated with the user or implicit user information associated with the user. Explicit user information associated with a user may include present online activities of the user (e.g., current browser activities, a search query submitted by the user), past online activities of the user (e.g., browser history, websites visited), present offline activities of the user (e.g., offline purchase activity, checking-in at a venue, going out to eat, visiting a new location, life events such as moving home, changing jobs, getting married), past offline activities of the user (e.g., offline purchase history, lifecycle history, repeated activities such as regular travel to a particular location or visits to certain types of restaurants), demographic information of the user (e.g., age, income, race, ethnicity, gender, citizenship, family status, education, profession), contact information or physical location (e.g., home or work address, email address, telephone numbers), personal interests or hobbies, social-networking information of the user, client devices used (e.g., brand, model, hardware, software), services or products purchased in the past, advertisements or landing pages responded to in the past (e.g., advertisements clicked on or forms submitted via the landing pages), or other suitable information associated with the user. Implicit user information associated with a user may include a present location of a device associated with the user (e.g., current GPS coordinates of the user's smartphone, an IP address of the user's client system), a past location of a device associated with the user (e.g., past GPS coordinates of the user's smartphone, a past IP address of the user's client system), a past time when a device associated with the user was at a past location, network connection status (e.g., service provider, connection speed or bandwidth), or other suitable information associated with the user. Although this disclosure describes accessing particular types of user information associated with a user, this disclosure contemplates accessing any suitable type of user information associated with a user.

User information may be obtained from various sources. As an example and not by way of limitation, when a visitor visits a publisher's webpage, the publisher, an advertiser through an agreement with the publisher, or an ad server serving one or more advertisements onto the webpage may set cookies in the visitor's browser. These cookies may record various types of information concerning the visitor, the visitor's device, or the visitor's online activities. The information stored in the cookies may be extracted and saved. The intent-marketing platform may have access to the information directly or may acquire the information from a third party. The intent-marketing platform may then incorporate the information as needed to derive user intent. Although this disclosure describes obtaining user information in a particular manner, this disclosure contemplates obtaining user information in any suitable manner.

In particular embodiments, relationships between pairs of intents may be defined. Relationships between pairs of intents may be defined as, for example, “manufactured by,” “has model number,” “has brand,” “acted in,” “contains,” another suitable relationship, or two or more such relationships. As an example and not by way of limitation, the user query “used pink iPod” may correspond to the user intents <condition=used; color=pink; product=iPod; brand=Apple>. The last user intent, <brand=Apple>, may be derived from the relationship between the user intent <product=iPod> “has brand of” <brand=Apple>. Such a relationship may be represented in the intent map graph by a link between the two intents. In particular embodiments, the relationship between two intents is directed or hierarchical, with one intent considered the parent and one the child. In such a case, the corresponding link in the intent map graph is directed from the parent intent to the child intent. As an example and not by way of limitation, there may be a one-way relationship from the intent <product=iPod> to the intent <brand=Apple>. Each of these user intents may have a relationship with other intents. It is possible for there to be more than one relationship between a pair of intents, and in such a circumstance it is also possible for one intent to be the parent in one relationship and the child in another. In particular embodiments, there will be at most one relationship between any pair of intents, in which case these relationships will impose a hierarchy on the intents. Although this disclosure describes particular relationships between particular intents, this disclosure contemplates any suitable relationships between any suitable intents.

In particular embodiments, relationships between pairs of intent topics may be defined. Relationships between pairs of intent topics may be defined as, for example, “contains,” “is the author of,” “acted in,” “has brand,” another suitable relationship, or two or more such relationships. Such a relationship may be represented in the intent map graph by a link between the two intent topics. In particular embodiments, the relationship between two intent topics is directed, with one intent topic considered the parent and one the child. In such a case, the corresponding link in the intent map graph is directed from the parent intent topic to the child intent topic. As an example and not by way of limitation, there may be a one-way relationship from the intent topic <product> to the intent topic <brand>, wherein each intent in the <product> intent topic has one associated intent in the <brand> intent topic, while each intent in the <brand> intent topic may have none, one, or multiple associated intents in the <product> intent topic. It is possible for there to be more than one relationship between a pair of intent topics, and in such a circumstance it is also possible for one intent topic to be the parent in one relationship and the child in another. In particular embodiments, there will be at most one relationship between any pair of intent topics, in which case these relationships will impose a hierarchy on the intent topics. Although this disclosure describes particular relationships between particular intent topics, this disclosure contemplates any suitable relationships between any suitable intent topics.

In particular embodiments, a relationship R_{A} between two intent topics induces relationships between pairs of intents (or key intents), one belonging to one intent topic and one belonging to the second intent topic. Each intent within an intent topic may be related by R_{A} to none, one, or many intents within the second intent topic. Such a relationship between a pair of intents may be represented in the intent map graph by a link between the two intents. As an example and not by way of limitation, the intent topic <model> may have a relationship R_{A} with the intent topic <model number>, wherein each intent in the <model> intent topic is related to zero or more intents in the <model number> intent topic. For example, the intent topic <model family> may include the key intent <model family=Razr>. This key intent may have a relationship R_{A} with the key intents <model number=V3, V3c, V3i, V3i DG, V3x>. In a particular embodiment, the inducing relationship R_{A} may be directed and the link between the two key intents may be directed from the key intent belonging to the parent intent topic to the key intent belonging to the child intent topic. Although this disclosure describes particular relationships between particular intent topics inducing particular relationships between particular intents, this disclosure contemplates any suitable relationships between any suitable intent topics inducing any suitable relationships between any suitable intents.

In particular embodiments, an intent-marketing platform may store one or more intent maps for one or more search campaigns. A particular intent map can reflect the particular search campaign that an advertiser is managing. For example, a retailer selling products in multiple product categories may choose to group those categories together into one search campaign, in which case an integrated intent map covering all product categories may be appropriate. Alternatively, the retailer may choose to establish separate search campaigns for separate product categories, in which case separate intent maps for each product category may be appropriate. In this latter case, the separate intent maps may include common intent topics and intents. In particular embodiments, the intents and relationships between intents can be defined in different ways in an intent map to achieve essentially the same or a similar end result. As an example and not by way of limitation, intent-marketing platform may host an intent map for the product category of “computers and computer peripherals.” One intent topic in the intent map might be <product>, and one intent (or key intent) within the <product> intent topic might be <laptop>. Names of specific laptop models, such as HP Pavilion dv6z, HP Envy 13, and Compaq Presario CQ61z, may be included as intents within the intent topic <product>, and be related to the key intent <laptop>. Alternatively, the intent map may include a separate intent topic <model name>, which contains the names of the specific laptop models as intents. In this case, a relationship “is product” between intent topics may be included in the intent map with <product> as the parent intent topic and <model name> as the child intent topic. The names of specific laptop models may be related by the “is product” relationship to the intent <product=laptop>. Although this disclosure describes particular intent maps for particular search campaigns, this disclosure contemplates any suitable intent maps for any suitable search campaigns.

In particular embodiments, an intent map may be created using a variety of data sources, such as, for example, query logs, keyword portfolios, product catalogs, website content, existing taxonomies (such as WordNet, Cyc, Wikipedia, etc.), marketer expertise, historical performance data from marketing campaigns, other suitable data sources, or two or more such data sources. As such, two intent maps created for the same search campaign using two different sets of data sources are unlikely to be identical. Further, after an intent map is created, it can be refined as new data becomes available, such as, for example, additional queries collected in a query log, input from a newly hired marketer, campaign performance data, other suitable new data, or two or more such new data sources. Although this disclosure describes making or updating an intent map using particular data sources, this disclosure contemplates making or updating an intent map using any suitable data sources.

In particular embodiments, an intent-marketing platform may include an intent map manager. An intent map manager is a software-as-a-service tool that may enable an advertiser to build and manage intent maps. The intent map manager may contain automated elements that allow the construction of an intent map in a partially- or fully-automated manner. In particular embodiments, the intent map manger may take input from the advertiser at any step of the process, allowing the advertiser to guide the construction of an intent map at whatever level of detail is required. To build an intent map, the advertiser may upload a number of data sources into the intent map manager, and the intent map manager may process the assets and recommend elements of a new intent map or additions to an existing intent map (such as, for example, new intent topics, new intents, or new relationships). Data sources that may be utilized by the intent map manager may include, for example, keyword lists, query logs, product catalogs, guided navigation facets, website content, text ad copies, linked lists containing keywords or text ad copies, other suitable data sources, or two or more such data sources. Although this disclosure describes building or managing an intent map in a particular manner, this disclosure contemplates building or managing an intent map in any suitable manner.

In particular embodiments, an intent-marketing platform may include a keyword generator. The intent-marketing platform may derive a plurality of keywords from an intent map based on one or more keyword templates. Keywords may be derived from keyword templates in a variety of ways. In particular embodiments, keywords may be derived from a keyword template based on intents and the hierarchy of intent topics in the associated intent map. As an example and not by way of limitation, when deriving a plurality of keywords based on a keyword template, the keyword generator may replace an intent topic contained in a keyword template with an intent from the intent topic or an intent from an intent topic that is an ancestor of the intent topic in the hierarchy. In particular embodiments, keywords may be derived from an intent map based on relationships between particular intents or intent topics. The relationships between the intents may be that of a first intent being, for example, a synonym, plural, misspelling, or substitute of a second intent. As an example and not by way of limitation, a relationship between particular intent topics may indicate that a first intent (belonging to a first intent topic) and a second intent (belonging to a second intent topic) are either eligible or not eligible to appear together in the plurality of keywords generated from an intent map. As another example and not by way of limitation, a relationship between a first intent belonging to a first intent topic and a second intent belonging to a second intent topic may indicate that the first intent and the second intent are eligible to appear together in the plurality of keywords generated from an intent map. Although this disclosure describes generating keywords and keyword templates in a particular manner, this disclosure contemplates generating keywords and keyword templates in any suitable manner.

In particular embodiments, a keyword generator may filter derived keywords based on the properties of the keywords. As an example and not by way of limitation, the keyword generator may filter a plurality of keywords by first estimating a marketing or advertising volume for the plurality of keywords. Then, the keyword generator may select, from the plurality of keywords, one or more keywords that are estimated to generate a relatively higher marketing or advertising volume. Although this disclosure describes filtering keywords in a particular manner, this disclosure contemplates filtering keywords in any suitable manner.

In particular embodiments, an advertiser may use a keyword generator to construct keyword templates. A keyword template may comprise one or more intent topics from an intent map. A keyword template may be constructed using keywords, expressions, placeholders or variable names (such as, for example, intent topics, intents, or key intents) from parts of the intent map. This may be done in a partially- or fully-automated manner using the intent map and various data sources. Data sources may include, for example, keyword lists, query logs, product catalogs, guided navigation facets, historical performance data from marketing campaigns, website content, other suitable data sources, or two or more such sources. In particular embodiments, a keyword template may be constructed based at least in part on a collection of known keywords. As an example and not by way of limitation, a keyword generator may analyze a collection of known keywords, such as a keyword list. The keyword generator may then select, from the collection of known keywords, one or more of the known keywords that are applicable to the intent map. The keyword generator may then construct a keyword template based on one or more of the selected known keywords. In particular embodiments, a keyword template may be constructed based at least in part on the historical performance of particular keywords. As an example and not by way of limitation, when selecting keywords that are applicable to an intent map for a plurality of products as part of constructing a keyword template, a keyword generator may select, from a collection of known keywords, one or more specific known keywords that are related to the plurality of products. The keyword generator may then analyze historical performance information of the specific known keywords that are related to the plurality of products. Then, to construct the keyword template, the keyword generator may select from the specific known keywords one or more known keywords that have a relatively higher performance with respect to one or more predetermined metrics (such as, for example, impression volume, click volume, conversion volume, click-through-rate, conversion rate, etc.). In particular embodiments, a keyword template may be constructed based at least in part on the intents associated with particular segments of particular keywords. As an example and not by way of limitation, when constructing a keyword template based on known keywords, a keyword generator may, for each known keyword, divide the known keyword into one or more segments. The keyword generator may then, for each segment, identify an intent from the intent map that aligns with the segment and then replace the segment with an intent topic from the intent map to which the intent belongs. In particular embodiments, a keyword template may be constructed based at least in part on one or more rules. As an example and not by way of limitation, an advertiser may then apply business rules to have the keyword generator combine templates with words/relationships in the intent map to generate highly relevant keywords at scale. In particular embodiments, one or more of the rules for constructing a keyword template may be based on one or more intent topics. As an example and not by way of limitation, the generated keywords may be tagged with the intent map relationships/intents of the words contained within the keyword when generating a keyword template. As another example and not by way of limitation, if one or more of the intent topics form a hierarchy, then one or more of the keyword templates may be constructed based on the hierarchy. In addition, the keyword generator may automatically query online traffic estimation tools (such as, for example, Google's AdWords Traffic Estimator) to determine the traffic volume that a generated keyword might expect. Keywords whose expected traffic volume falls below some threshold may be discarded by the keyword generator. Although this disclosure describes constructing keyword templates in a particular manner, this disclosure contemplates constructing keyword templates in any suitable manner.

In particular embodiments, an intent-marketing platform may include a keyword grouper. The keyword grouper may cluster a plurality of keywords into one or more keyword clusters. An advertiser may use a keyword grouper to automatically create a themed ad group. Advertisers may specify a set of intent topics or key intents along which to cluster keywords. The keyword grouper may then automatically group keywords by the related intent or intents. As an example and not by way of limitation, the keyword grouper may group a plurality of keywords based on a set of intent topics by grouping all keywords that for each intent topic in the set of intent topics commonly share a same intent from that intent topic into a keyword cluster. Thus, the keywords within an ad group may have identical intents (among the intent topics or intents and at the level the advertiser chose to group by). In particular embodiments, the keyword grouper may use the linguistic similarity of keywords or keyword performance (such as, for example, quality score, impression volume, click volume, click-through rate, conversion rate, profitability, other performance parameters, or two or more such parameters) to create ad groups. Advertisers may also flag certain keywords to be in their own separate group, which may be useful for high volume keywords or more important keywords. Although this disclosure describes creating ad groups in a particular manner, this disclosure contemplates creating ad groups in any suitable manner.

In particular embodiments, an intent-marketing platform may include an ad copy generator. Ad copy management is important for improving click-through rates, since relevant ad copy may lead to higher click-through-rates. An advertiser may use an ad copy generator to automatically generate ad copy for an ad group. Advertisers may define ad-copy templates that utilize placeholder or variable names (such as, for example, intent topics, intents, or key intents) from parts of the intent map. This may be done in a partially- or fully-automated manner using the intent map and various data sources. Data sources may include, for example, proposed or exiting ad group structure with associated intents, sample text ad copies, other suitable data sources, or two or more such sources. The ad copy generator may automatically propose combinations of intent topics, intents, or key intents that the advertiser may utilize in ad copy templates. The ad copy generator may also automatically propose ad copy templates. Next, the ad copy generator may assign the ad copy templates to one or more ad groups that share one or more intent topics, intents, or key intents. The ad copy generator may then combine the ad copy templates with words/relationships in the intent map to create ad copy for a particular combination of intent topics, intents, or key intents. The advertiser may define business rules to guide the combination of ad copy templates with intent map words/relationships. Although this disclosure describes generating ad copy in a particular manner, this disclosure contemplates generating ad copy in any particular manner.

In particular embodiments, ads generated using the intent-marketing platform may be constructed using an ad template, wherein the ad copy is one of the attributes of the ad template. By using an ad template, an ad may be customized to provide relevant ad copy for each product of an advertiser. An advertiser may leverage an intent map to develop relevant ad copy in a scalable manner. In particular embodiments, an advertiser may “templatize” an ad copy title as: “Buy a <brand> <product> today!” where <brand> and <product> are intent topics in an intent map for a given product category. As an example and not by way of limitation, an ad template may have the ad attributes <title>, <description 1>, <description 2>. If the ad template is for furniture on sale, the ad template may be:

| Ad Attributes | Ad Template | Example Ad |
|---|---|---|
| Title | Great deals on <furniture+> | Great deals on couches |
| Description 1 | <call to action> the perfect | Buy the perfect couch for |
| | <furniture> for your home. | your home. On sale today! |
| | On sale today! | |
| Description 2 | Just $50 for shipping! | Just $50 for shipping! |

The example ad template contains the intent topics <furniture> and <call to action>. The “+” in the <furniture+> intent topic indicates using the plural of the intent, which may be used to achieve grammatical correctness in the ad copy. Other syntax may be used in the ad templates in order to achieve ad copy that meets length restrictions that may be imposed by a publisher. As an example and not by way of limitation, the use of “{ }” indicates that the text or intent topic in the braces is optional and the use of “[|]” indicates that one of the options in the brackets should be chosen. Because various intents may be of various character lengths, these syntaxes may be used to provide alternative or optional text or intent topics so that ad copy templates may produce ad copy that does not violate a publisher's length restrictions. The ad template may be applied to an ad group associated with particular intent values for these intent topics. The associated intent map may include the intent “sale” and a relationship between the intent “sale” and the intents in the <furniture> intent topic to indicate which furniture products are on sale. The ad template may be tagged with the intent “sale” and may be applied only to ad groups associated with products (such as, for example, <furniture> intents) where there is a relationship with the “sale” intent. For each ad group to which this ad template is applied, the particular ad copy for the ad group is created by substituting the particular intent values for the intent topics in the ad template. The example ad shows the advertisement the ad template would generate for key intents <furniture=couch> and <call to action=buy>. In particular embodiments, each product on an advertiser's website or in the advertiser's product catalog may be associated with a particular ad copy. Each product may be matched with one or more intents from one or more intent topics in the intent map. Each ad group may be matched to one or more products based on the intents matched to the products and the intents associated with the ad group. Although this disclosure describes generating particular ads in a particular manner, this disclosure contemplates generating any suitable ads in any suitable manner.

In particular embodiments, an intent-marketing platform may include an intent-based ad-copy optimizer. Some advertiser tools may optimize ad copy based on average click-through rates or average profitability. The intent-marketing platform may allow a marketer to optimize ad copy by intent. As an example and not by way of limitation, a given ad copy might be profitable for some intents and unprofitable for other intents. In addition, advertisers may be able to assign features to ad copy, such as, for example, “memorial day promo,” or “free shipping promo.” These ad copy features may then be used to efficiently manage ad copy. As an example and not by way of limitation, an ad copy feature may be used to activate or deactivate all “memorial day promo” ad copy. These ad copy features may also be incorporated in automatic optimization of ad copy. As an example and not by way of limitation, for a particular set of intents, the ad copy feature “free shipping promo” may be favored over a “buy-one-get-one-free promo.” Although this disclosure describes optimizing ad copy in a particular manner, this disclosure contemplates optimizing ad copy in any suitable manner.

In particular embodiments, an intent-marketing platform may include an intent-based ad-copy experimenter. Advertisers may desire to experiment with alternative ad copies to determine which are most effective in driving the advertiser's marketing objective. The intent-marketing platform may allow a marketer to easily set up ad copy experiments and to track such experiments by intent, by ad copy template, or by ad copy feature. As an example and not by way of limitation, an advertiser may conduct an ad copy experiment to determine for which intents a first ad copy template is preferred to a second ad copy template. The ad copy experimenter may support A/B/N tests, in which two or more of an ad copy, an ad copy template, or an ad copy feature alternatives are tested. The ad copy experimenter may support multi-variate tests, in which intents, ad copy templates, or ad copy features are variables in the test, with the objective being to isolate the effects of two or more potential causal factors. The ad copy experimenter may facilitate the marketer in designing, tracking, analyzing and reporting on such tests. Although this disclosure describes conducting ad copy experiments in a particular manner, this disclosure contemplates conducting ad copy experiments in any suitable manner.

In particular embodiments, an intent-marketing platform may include an intent-to-guided navigation server. Advertisers may use guided navigation systems on their websites to help consumers find products (such as, for example, physical products, software products, or services). These guided navigation systems may allow consumers to select or search by particular product details. As an example and not by way of limitation, a consumer shopping for digital cameras might be able to filter a search for digital cameras by price, brand, number of megapixels, other suitable product details, or two or more such product details. The underlying intents within a keyword may correspond to guided navigation product detail on an advertiser's website. An intent-to-guided navigation server may allow advertisers to map intents to guided navigation product details, and to map product details to URL syntax. The intent-marketing platform may then publish or dynamically generate a guided navigation URL for a particular intent. These URLs can be associated in the search campaign to, for example, intents, keywords, ad groups, or ad copies. A user clicking on a text ad in the search campaign may be directed to the page referenced by the URL. Although this disclosure describes searching for products in a particular manner, this disclosure contemplates searching for products in any suitable manner.

In particular embodiments, an intent-marketing platform may include a dynamic landing page server. Advertisers may want to show targeted landing pages to users who click on advertisements. A dynamic landing page server may allow any part of a landing page to be instrumented to serve dynamic content. The dynamic landing page server may allow advertisers to add new variations of content. New variations of content may be targeted to (or restricted from) specific intents, as defined in the intent map. In addition, the dynamic landing page server may optimize content for each unique combination of intents. As an example and not by way of limitation, the one or more intents may be passed in as part of the URL, such that the landing page may be dynamically generated based on the one or more intents. Although this disclosure describes dynamically generating landing pages in a particular manner, this disclosure contemplates dynamically generating landing pages in any suitable manner.

In particular embodiments, an intent-marketing platform may include an intent-based URL manager, which may manage both display and destination URLs. URLs in intent maps may be managed using advertiser intents, which allows for scalability across publishers. URL management is important for improving click-through rates and conversion rates. Relevant display URLs in ads may lead to higher click-through-rates and relevant landing pages set through destination URLs may lead to higher conversion rates. In particular embodiments, ads generated using the intent-marketing platform are constructed using an ad template, wherein the display URL is one of the attributes of the ad template. By using an ad template, an ad may be customized to provide relevant display URLs for each product of an advertiser. An advertiser may leverage an intent map to develop display URLs in a scalable manner. In particular embodiments, a search-engine marketer may structure URLs as: “store.<brand>.com/<product>.html,” where <brand> and <product> are intent topics in an intent map for a given product category. As an example and not by way of limitation, an ad template may have the ad attributes <title>, <description 1>, <description 2>, and <display URL>. If the ad template is for products with free engraving, the ad template may be:

| Ad Attributes | Ad Template | Example Ad |
|---|---|---|
| Title | <product> with Free | IPod with Free |
| | Engraving | Engraving |
| Description 1 | Buy from <brand>, with | Buy from Apple, with |
| | Personal Engraving | Personal Engraving |
| Description 2 | Fast, Free Shipping! | Fast, Free Shipping! |
| Display URL | store.<brand>.com/<product> | store.apple.com/iPod |

The example ad template contains the intent topics <product> and <brand>. The ad template may be applied to an ad group associated with particular intent values for these intent topics. The associated intent map may include the intent “free engraving” and a relationship between the intent “free engraving” and intents in the <product> intent topic to indicate which products are eligible for free engraving. The ad template may be tagged with the intent “free engraving” and may be applied only to ad groups associated with products (<product> intents) for which there is a relationship with the “free engraving” intent. For each ad group to which this ad template is applied, the particular ad copy for the ad group is created by substituting the particular intent values for the intent topics in the ad template. The example ad shows the advertisement the ad template would generate for key intents <product=iPod> and <brand=Apple>. An advertiser typically organizes destination URLs based on categorization of the products it sells on its website. These URLs may usually be found through the sitemap of the advertiser's website or a product/inventory catalog. In particular embodiments, each product on an advertiser's website or in the advertiser's product catalog may be identified with a particular URL. Each product may be matched with one or more intents from one or more intent topics in the intent map. Each ad group may be matched to one or more products based on the intents matched to the products and the intents associated with the ad group. The destination URL for an ad copy associated with an ad group may be the URL identified with a product matched to the ad group. Alternatively, rather than matching an ad group to a product and utilizing the URL with which that product is identified, each ad group may be matched directly with a URL. This may be achieved by “templatizing” the advertiser's existing destination URLs to create destination URL templates. As an example and not by way of limitation, the destination URL “store.apple.com/ipod.html” may be “templatized” to create the destination URL template “store.<brand>.com/<product>.html”. Each ad group or keyword generated through a keyword template may be assigned a destination URL template based on the maximum number of overlapping intents between the ad group or keyword and the destination URL template. For example:

| | | Assigned | |
|---|---|---|---|
| Ad group intent | Example | Destination URL | Resultant |
| topics | keyword | Templates | Destination URL |
| <brand> | Apple ipod | store.<brand>.com/ | store.apple.com/ |
| <product> | blue | <product>.html | ipod.html |
| <color> | | | |
| <brand> <size> | Apple 16gb | store.<brand>.com/ | store.apple.com/ |
| <brand> | Apple | store.<brand>.com/ | store.apple.com/ |
| <product> | Ipod blue | store.<brand>.com/ | Store.apple.com/ |
| <color> | | <product>.html | ipod.html |

In the first example, the intent topics <brand>, <product>, and <color> are matched to the keywords “Apple ipod blue.” The URL manager may assign the URL template store.<brand>.com/<product>.html because it has two intents that overlap (<brand> and <product>) with the keyword template, whereas the template store.<brand>.com only has one intent topic that overlaps (<brand>). In the second and third examples, the intent topics <brand> and <size> are matched to the keywords “Apple 16gb” while the intent topic <brand> is matched to the keyword “Apple.” In both situations, the URL manager may assign the URL template store.<brand>.com because of the overlap with the intent topic <brand>. In the fourth example, the intent topics <product> and <color> are matched with the keywords “Ipod blue.” The URL manager may assign the URL template store.<brand>.com/<product>.html because it has two intents that overlap (<brand> and <product>). The intent topics <brand> and <products> are both identified in this example because of the relationship between these intent topics in the associated intent map, i.e., the brand “Apple” is associated with many intents in the <product> intent topic. Brand “Apple” is inferred for the keyword “ipod blue” because iPods are manufactured by Apple, Inc. In particular embodiments, a destination URL may be assigned to a keyword based on the semantic similarity between the keyword and the webpage referenced by the destination URL. The semantic similarity between a keyword and a webpage may be computed using any standard technique. As an example and not by way of limitation, the keyword may be submitted to a search engine, the top some number of results snippets concatenated into a set of words, and the set of words represented by a vector of word counts. Similarly the webpage can be represented as a vector of word counts of all the words on the webpage. The semantic similarity between the keyword and the webpage may then be computed as the cosine similarity between the two vectors. In particular embodiments, instead of maintaining hierarchies based on categorization of the advertiser's products, some advertiser's websites simplify how URLs are managed by providing a generic search page that shows a list of products based on a search query. These websites generally need the appropriate query/context to be passed as a parameter in the URL. An advertiser websites that require appropriate query/context parameters may leverage an intent map to develop destination URLs in a scalable manner. In particular embodiments, a search-engine marketer may structure destination URLs as: “store.<brand>.com/search?query=<product>.” As an example and not by way of limitation, for the search query “apple ipod,” the advertiser may use the destination URL “store.apple.com/search?query=ipod,” where the intent map would match the keywords “apple” and “ipod” to the key intents <brand=Apple> and <product=iPod>. Destination URLs may be applied on both ads and keywords to enable consistency for proper landing page testing as both keyword and ad destination URLs may be used by a search engine for any given search query. The landing page manager may set destination URLs by referencing intents across both keywords and ads. As new keywords are generated (such as, for example, from search query logs and other sources), intent-based rules defined by the advertiser or search-engine marketer for destination URLs may be applied. As an example and not by way of limitation, if the existing keywords include “iPod on sale” and “Apple iPod,” there may be an intent-based rule that “if <product=iPod>, then the destination URL is “store.<brand>.com/<product>.” If new keywords include “Apple iPod on sale,” the same rule could be applied. Although this disclosure describes managing display and destination URLs in a particular manner, this disclosure contemplates managing display and destination URLs in any suitable manner. Moreover, although this disclosure describes particular display and destination URLs and particular ad templates, this disclosure contemplates any suitable display and destination URLs and any suitable ad templates.

In particular embodiments, an intent-marketing platform may include an intent-based reporting tool. Some advertiser tools offer performance reporting (such as, for example, clicks, cost, revenue, margin) by keyword, ad group, and campaign. The intent-marketing platform may provide performance reporting not only by these dimensions, but also by underlying intent. Advertisers may be able to see which intent topics, key intents, or intents are profitably driving business for them, and then take action to enhance their campaign by expanding keywords, ad copy, and landing pages around highly productive intents. Similarly, advertisers may be able to see which intent topics, key intents, or intents are not profitable for them, and then take action to enhance their campaign by turning off keywords or deploying negative keywords associated with non-productive intents.

In particular embodiments, an intent-marketing platform may include a full-funnel reporting tool. Some advertiser tools only focus on pre-click campaign assets—keywords and ad copy. The intent-marketing platform may span both the pre- and post-click search experience, allowing advertisers to see how the full path of certain users—keyword to ad copy to landing page—performed relative to other paths. Having full-funnel business intelligence can be used to avoid making decisions that maximize locally but are globally sub-optimal, e.g., optimizing on an ad copy based on click-through rate, as opposed to optimizing an ad copy based on profitability.

In particular embodiments, an intent-marketing platform may include an intent-based bid manager. Some advertiser tools are focused on managing bids across a large portfolio of keywords. Managing bids effectively requires accurate estimates of performance metrics. A difficult bid management problem is estimating performance metrics on keywords with extremely low volume, or “tail” keywords. Because tail keywords have extremely low query and click volume, building statistically significant (and accurate) estimates of performance metrics for these keywords is extremely difficult. The intent-marketing platform bid management algorithms may incorporate the underlying intents for keywords. Because intents are shared across many different keywords (50 different queries may actually have the same underlying intent), intents allow intent-marketing bid management algorithms to utilize data from one or more keywords to optimize bids for similar keywords. The result may be more accurate bids on tail keywords sooner. Although this disclosure describes managing bids in a particular manner, this disclosure contemplates managing bids in any suitable manner.

In particular embodiments, an intent-marketing platform may include an intent-extractor tool. Intent maps may be used to determine the underlying user intent of a given keyword or query and to determine the underlying advertiser intent of a given product or webpage. An intent-extractor tool may derive one or more user intents from user information associated with a user. Similarly, an intent-extractor tool may crawl a given advertiser's website and derive one or more advertiser intents for each product or webpage in the site. Once advertiser intents are assigned for each product or webpage, the advertiser may then assign landing pages from within the advertiser's existing website to keywords, ad groups, or ad copy and thereby create highly relevant/consistent search experiences. Although this disclosure describes deriving user intents and advertiser intents in a particular manner, this disclosure contemplates deriving user intents and advertiser intents in any suitable manner.

The various components of the intent-marketing platform described above are only provided as an example and are not intended to be limiting. Some of these components are illustrated in FIG. 2C, which shows an example of process 240 for managing an intent-based keyword portfolio. Process 240 illustrates how various components and processes of the intent-marketing platform and the intent marketplace may relate to each other. Particular embodiments can include, some, all, or none of the components described above, and can include other components. The intent-marketing platform may provide many advantages to advertisers. One advantage is that the advertiser may be able to create more relevant, consistent, end-to-end paid search experiences. Another advantage is that the advertiser may experience higher conversion rates because the users' search experiences may be more relevant and consistent. Yet another advantage is that the advertiser may realize a higher return-on-investment or higher return-on-average-spend on its advertising campaigns because more relevant campaigns may lead to higher quality scores (implying lower costs to achieve the same click volumes), bidding that more accurately reflects the value driven by specific keywords (reducing costs on poorly performing keywords, increasing volumes on better performing keywords), higher conversion, and more revenue per conversion, all of which contribute to higher ROI or higher ROAS. Another advantage is that advertisers may be able to place higher bids across an advertising campaign because of the higher ROI or higher ROAS. Bidding higher may result in higher average position, which in turn may result in greater click volume and revenue for the advertiser. Yet another advantage is that advertisers may scale their campaigns more simply and easily by eliminating much of the manual work and manpower that is typically required to make highly relevant and consistent search campaigns. By managing intents rather than directly managing keywords, an advertiser may be able to scale its campaigns to contain several orders of magnitude more keywords without requiring any increase in labor. Such an increase in scale may result in higher campaign performance metrics, for example, higher impression volumes, higher click volumes, higher conversion volumes, higher revenue, or higher contribution margin. A further advantage is that advertisers may realize a faster time-to-market because the intent-marketing platform may allow the marketer to implement a search campaign more quickly than is typically required to manually make a relevant and consistent search campaign. The advantages listed above are provided as examples only and are not intended to be limiting. Although this disclosure describes and illustrates particular steps of the process of FIG. 2C as occurring in a particular order, this disclosure contemplates any suitable steps of the process of FIG. 2C as occurring in any particular order.

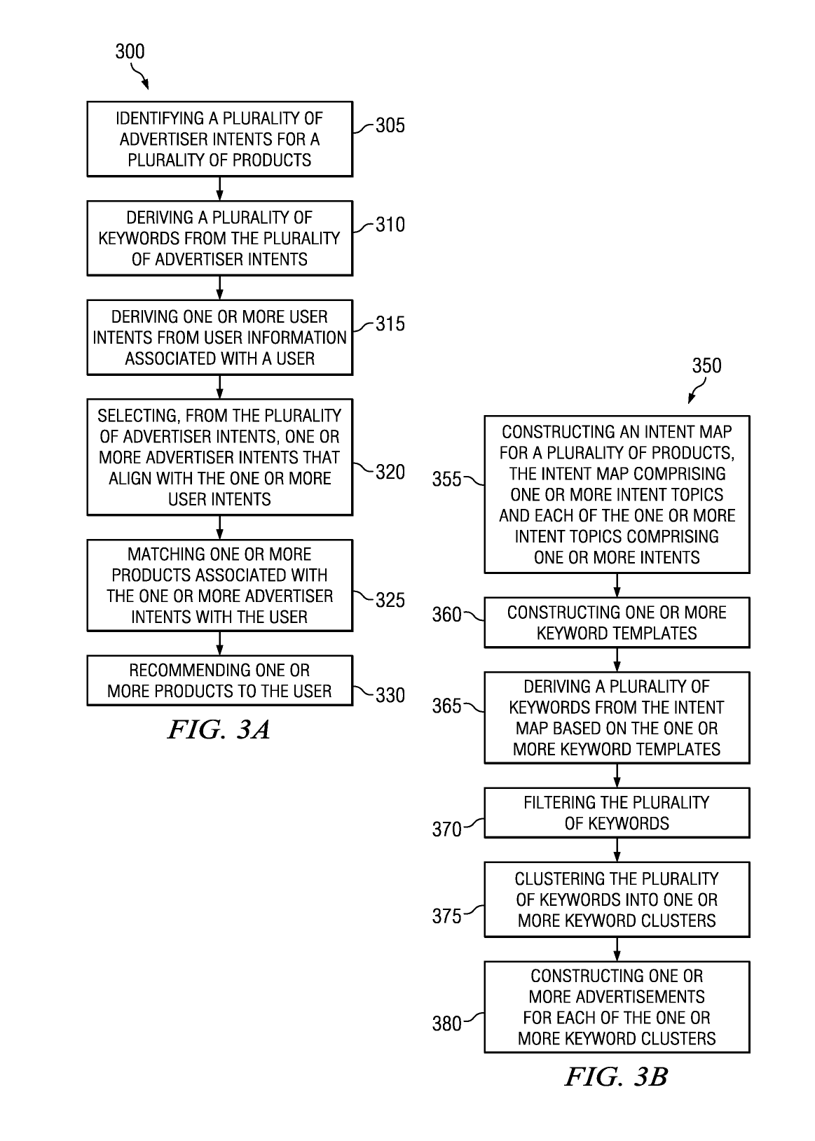

FIG. 3A illustrates an example method 300 for matching products and users based on their respective intents. The method begins at step 305, where an advertiser 150 may identify a plurality of advertiser intents for a plurality of products. At step 310, the advertiser 150 may derive a plurality of keywords from the plurality of advertiser intents. At step 315, the advertiser 150 may derive one or more user intents from the user information associated with a user, such as, for example, a visitor 130. At step 320, the advertiser 150 may select, from the plurality of advertiser intents, one or more advertiser intents that align with the one or more user intents. At step 325, the advertiser 150 may match one or more products associated with the one or more advertiser intents with the user. At step 330, the advertiser 150 may recommend one or more products to the user. Although this disclosure describes and illustrates particular steps of the method of FIG. 3A as occurring in a particular order, this disclosure contemplates any suitable steps of the method of FIG. 3A occurring in any suitable order. Moreover, although this disclosure describes and illustrates particular components carrying out particular steps of the method of FIG. 3A, this disclosure contemplates any suitable combination of any suitable components carrying out any suitable steps of the method of FIG. 3A.

FIG. 3B illustrates an example method 350 for matching advertiser intents to keywords. The method begins at step 355, where an advertiser 150 may construct an intent map for a plurality of products. The intent map may comprise one or more intent topics and each of the one or more intent topics may comprise one or more intents. At step 360, the advertiser 150 may construct one or more keyword templates. At step 365, advertiser 150 may derive a plurality of keywords from the intent map based on the one or more keyword templates. At step 370, the advertiser 150 may filter the plurality of keywords. At step 375, the advertiser 150 may cluster the plurality of keywords into one or more keyword clusters. At step 380, the advertiser 150 may construct one or more advertisements for each of the one or more keyword clusters. Although this disclosure describes and illustrates particular steps of the method of FIG. 3B as occurring in a particular order, this disclosure contemplates any suitable steps of the method of FIG. 3B occurring in any suitable order. Moreover, although this disclosure describes and illustrates particular components carrying out particular steps of the method of FIG. 3B, this disclosure contemplates any suitable combination of any suitable components carrying out any suitable steps of the method of FIG. 3B.

### Systems and Methods

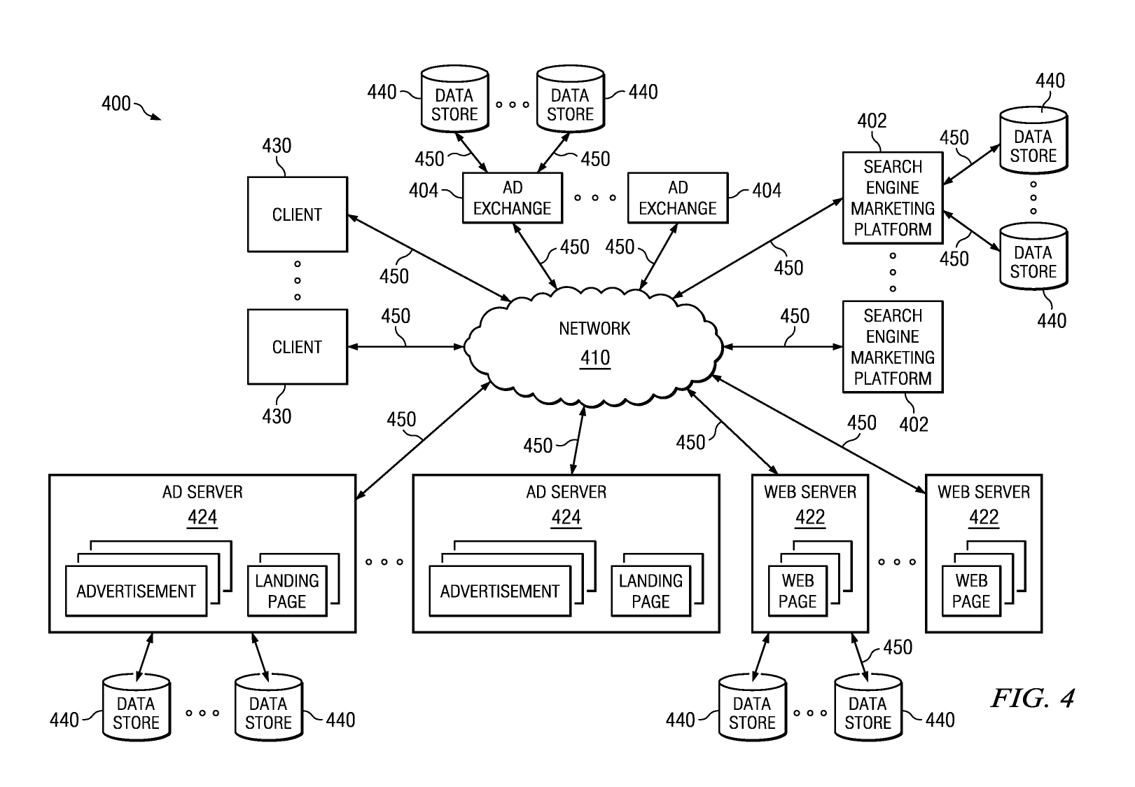

FIG. 4 illustrates an example search engine marketing platform 402 in a network environment 400. Network environment 400 includes a network 410 coupling one or more ad exchanges 110, one or more search engine marketing platforms 402, one or more advertising servers (ad servers) 424, one or more web servers 422, and one or more clients 430 to each other. Although not shown, other types of servers may also be included in network environment 400. For example and without limitation, network 410 may also couple one or more news servers, mail servers, message servers, file servers, application servers, exchange servers, database servers, proxy servers, etc. to each other or to ad exchanges 404, search engine marketing platforms 402, ad servers 424, web servers 422, or clients 430. This disclosure contemplates any suitable network environment 400. As an example and not by way of limitation, although this disclosure describes and illustrates a network environment 400 that implements a client-server model, this disclosure contemplates one or more portions of a network environment 400 being peer-to-peer, where appropriate. Particular embodiments may operate in whole or in part in one or more network environments 400. In particular embodiments, one or more elements of network environment 400 provide functionality described or illustrated herein. Particular embodiments include one or more portions of network environment 400. Network environment 400 includes a network 410 coupling one or more ad servers 424, one or more web servers 422, one or more clients 430, one or more ad exchanges 404, and one or more search engine marketing platforms 402 to each other. This disclosure contemplates any suitable network 410. As an example and not by way of limitation, one or more portions of network 410 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 410 may include one or more networks 410.

Links 450 couple ad servers 424, web servers 422, clients 430, ad exchanges 404, and search engine marketing platforms 402 to each other. This disclosure contemplates any suitable links 450. As an example and not by way of limitation, one or more links 450 each include one or more wireline (such as, for example, Digital Subscriber Line (DSL) or Data Over Cable Service Interface Specification (DOCSIS)), wireless (such as, for example, Wi-Fi or Worldwide Interoperability for Microwave Access (WiMAX)) or optical (such as, for example, Synchronous Optical Network (SONET) or Synchronous Digital Hierarchy (SDH)) links 450. In particular embodiments, one or more links 450 each includes an intranet, an extranet, a VPN, a LAN, a WLAN, a WAN, a MAN, a communications network, a satellite network, a portion of the Internet, or another link 450 or a combination of two or more such links 450. Links 450 need not necessarily be the same throughout network environment 400. One or more first links 450 may differ in one or more respects from one or more second links 450.

This disclosure contemplates any suitable ad server 424 or web server 422. As an example and not by way of limitation, one or more ad servers 424 or web servers 422 may each include one or more advertising servers, applications servers, catalog servers, communications servers, database servers, exchange servers, fax servers, file servers, game servers, home servers, mail servers, message servers, news servers, name or DNS servers, print servers, proxy servers, sound servers, standalone servers, web servers, or web-feed servers. In particular embodiments, an ad server 424 or web server 422 may includes hardware, software, or both for providing the functionality of ad server 424 or web server 422. As an example and not by way of limitation, a web server 422 that operates as a web server may be capable of hosting websites containing webpages or elements of webpages and include appropriate hardware, software, or both for doing so. In particular embodiments, a web server may host HTML or other suitable files or dynamically create or constitute files for webpages on request. In response to a Hyper Text Transfer Protocol (HTTP) or other request from a client 430, the web server 422 may communicate one or more such files to client 430. As another example, a web server 422 that operates as a mail server may be capable of providing e-mail services to one or more clients 430. As another example, an ad server 424 or web server 422 that operates as a database server may be capable of providing an interface for interacting with one or more data stores (such as, for example, data stores 440 described below).

In particular embodiments, each web server 422 or each ad server 424 may be a unitary server or may be a distributed server spanning multiple computers or multiple datacenters. In particular embodiments, each web server 422 or each ad server 424 may include hardware, software, or embedded logic components or a combination of two or more such components for carrying out the appropriate functionalities implemented or supported by web server 422 or ad server 424. For example, a web server 422 is generally capable of hosting websites containing webpages or particular elements of webpages. More specifically, a web server 422 may host HTML files or other file types, or may dynamically create or constitute files upon a request, and communicate them to clients 430 in response to HTTP or other requests from clients 430. An ad server 424 is generally configured to place advertisements (e.g., advertisements 152 as illustrated in FIG. 1) or advertising related content in ad spaces.

In particular embodiments, one or more links 450 may couple an ad server 424, web server 422, ad exchange, or search engine marketing platform 402 to one or more data stores 440. A data store 440 may store any suitable information, and the contents of a data store 440 may be organized in any suitable manner. As an example and not by way or limitation, the contents of a data store 440 may be stored as a dimensional, flat, hierarchical, network, object-oriented, relational, XML, or other suitable database or a combination or two or more of these. A data store 440 (or an ad server 424, web server 422, ad exchange 404, or search engine marketing platform 402 coupled to it) may include a database-management system or other hardware or software for managing the contents of data store 440. The database-management system may perform read and write operations, delete or erase data, perform data deduplication, query or search the contents of data store 440, or provide other access to data store 440.

In particular embodiments, one or more of ad server 424, web server 422, ad exchange 404, or search engine marketing platform 402 may each include one or more search engines. A search engine may include hardware, software, or both for providing the functionality of search engine. As an example and not by way of limitation, a search engine may implement one or more search algorithms to identify network resources in response to search queries received at search engine, one or more ranking algorithms to rank identified network resources, or one or more summarization algorithms to summarize identified network resources. In particular embodiments, a ranking algorithm implemented by a search engine may use a machine-learned ranking formula, which the ranking algorithm may obtain automatically from a set of training data constructed from pairs of search queries and selected Uniform Resource Locators (URLs), where appropriate.

In particular embodiments, one or more servers 420 may each include one or more data monitors/collectors 424. A data monitor/collection 424 may include hardware, software, or both for providing the functionality of data collector/collector 424. As an example and not by way of limitation, a data monitor/collector 424 at a server 420 may monitor and collect network-traffic data at server 420 and store the network-traffic data in one or more data stores 440. In particular embodiments, server 420 or another device may extract pairs of search queries and selected URLs from the network-traffic data, where appropriate.

In particular embodiments, an ad server 424 includes one or more servers or other computer systems for hosting advertisements for inclusion in webpages hosted by web servers 422. The present disclosure contemplates any suitable ad servers 424. Examples of ad serving platforms include, without limitation, DOUBLECLICK DART for PUBLISHERS, or GOOGLE ADSENSE. One or more ad servers 424 may be operated by an advertiser (e.g., advertiser 150 as illustrated in FIG. 1). A webpage may include elements hosted by any combination of web servers 422 and ad servers 424. When a web browser at a client 430 renders a webpage, the web browser may retrieve and load one or more elements of the webpage from one or more web servers 422, as directed by one or more HTML or other files for rendering the webpage. The web browser may retrieve and load one or more advertisements (e.g., advertisement 152 as illustrated in FIG. 1) placed in the webpage from one or more ad servers 424, similarly as directed by the HTML or other files for rendering the webpage.

In particular embodiments, one or more data storages 440 may be communicatively linked to one or more severs (e.g., web servers 422 or ad servers 424) via one or more links 450. In particular embodiments, data storages 440 may be used to store various types of information or data. In particular embodiments, the data stored in data storages 440 may be organized according to specific data structures. Particular embodiments may provide interfaces that enable servers (e.g., web servers 422 or ad servers 424) or clients 430 to manage (e.g., retrieve, modify, add, or delete) the information stored in data storage 440. In particular embodiments, data storage 440 may have suitable types of database software, such as, for example and without limitation, ORACLE DATABASE, SYBASE SQL SERVER, or MICROSOFT SQL SERVER, which are capable of managing the data stored in data storage 440 and enabling web servers 422, ad servers 424, or clients 430 to access the stored data. The present disclosure contemplates any suitable data storage 440.

This disclosure contemplates any suitable clients 430. A client 430 may enable a user at client 430 to access or otherwise communicate with network 410, ad server 424, web server 422, ad exchange 404, search engine marketing platform 402, or clients 430. As an example and not by way of limitation, a client 430 may have a web browser, such as MICROSOFT INTERNET EXPLORER or MOZILLA FIREFOX, and may have one or more add-ons, plug-ins, or other extensions, such as GOOGLE TOOLBAR or YAHOO TOOLBAR. A client 430 may be an electronic device including hardware, software, or both for providing the functionality of client 430. As an example and not by way of limitation, a client 430 may, where appropriate, be an embedded computer system, an SOC, an SBC (such as, for example, a COM or SOM), a desktop computer system, a laptop or notebook computer system, an interactive kiosk, a mainframe, a mesh of computer systems, a mobile telephone, a PDA, a netbook computer system, a server, a tablet computer system, or a combination of two or more of these. Where appropriate, a client 430 may include one or more clients 430; be unitary or distributed; span multiple locations; span multiple machines; span multiple datacenters; or reside in a cloud, which may include one or more cloud components in one or more networks.

A client 430 may enable its user to communicate with other users at other clients 430 or with web servers 422. For example, a user (e.g., visitor 130 as illustrated in FIG. 1) at client 430 may enter a Uniform Resource Locator (URL) or other address directing the web browser to web server 422, and the web browser may generate a HTTP request and communicate the HTTP request to web server 422. Web server 422 may accept the HTTP request and communicate to client 430 one or more HTML files responsive to the HTTP request. Client 430 may render a webpage based on the HTML files from web server 422 for presentation to the user. The present disclosure contemplates any suitable webpage files. As an example and not by way of limitation, webpages may render from HTML files, Extensible HyperText Markup Language (XHTML) files, or Extensible Markup Language (XML) files, according to particular needs. Such pages may also execute scripts such as, for example and not by way of limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

The present disclosure contemplates any suitable webpages. As an example and not by way of limitation, webpages hosted by web servers 422 may be static or dynamic. In particular embodiments, multiple webpages stored together in a common directory at a web server 422 make up a website or a portion of a website. In particular embodiments, a webpage may include one or more elements. As an example and not by way of limitation, presented (or rendered) elements of a webpage may include static text, static images, animated images, audio, video, interactive text, interactive illustrations, buttons, hyperlinks, or forms. Such elements may each occupy a particular space on the webpage when displayed. Internal (or hidden) elements of a webpage may include, for example and not by way of limitation, comments, meta elements, databases, diagramation and style information, and scripts, such as JAVASCRIPT. One or more elements of a webpage may be inline frames (IFrames) which enable web developers to embed HTML documents into other HTML documents. Herein, reference to a document may encompass a webpage, where appropriate. Reference to an element of a webpage may encompass one or more portions of a webpage file for rendering the element, and vice versa, where appropriate.

One or more elements of a webpage may be advertisements. A position in the webpage where an advertisement is placed may be referred to as an ad space. In particular embodiments, an advertisement has various attributes. As an example and not by way of limitation, attributes of an advertisement may include format (such as text, image, video, audio, animation, gadget, etc.); size; webpage position (such as top, left, above the fold, below the fold, etc.); inclusion method (such as being included in the HTML file for the webpage, being in an IFrame in the HTML file, or being rendered by execution of a script); presentation mode (such as inline, pop-up, pop-under, pre-roll, etc.); destination landing page URL; ad server (such as DOUBLECLICK DART for ADVERTISERS or GOOGLE ADWORDS); expected click-through rate (eCTR); an ad quality score; one or more targeted keywords and/or one or more targeted publishers; and advertiser. Online advertising campaigns (which may encompass multiple advertisements at multiple publishers) may have similar attributes. As described below, particular embodiments collect information about advertisements, such as their attributes, for use by advertisers in the planning and management of their online advertising. Particular embodiments similarly collect information about online advertising campaigns. Particular embodiments may store the collected information in one or more data storages 440.

In particular embodiments, an ad exchange 404 (such as, for example ad exchange 110 as illustrated in FIG. 1) may reside or be implemented on one or more servers (e.g., exchange servers). Ad exchange 404 may be implemented as hardware, software, or embedded logic components or a combination of two or more such components and capable of carrying out the appropriate functionalities such as buying and selling ad inventories, managing bids or advertising orders, etc.

In particular embodiments, a search engine marketing platform may reside or be implemented on one or more servers (e.g., application servers) and may be operated by a broker (e.g., broker 140 as illustrated in FIG. 1) on behalf of or representing one or more advertisers (e.g., advertisers 150 as illustrated in FIG. 1) or by an advertiser (e.g., advertisers 150 as illustrated in FIG. 1). Search engine marketing platform 402 may be implemented as hardware, software, or embedded logic components or a combination of two or more such components and capable of carrying out the appropriate functionalities such as selecting ad inventories, determining bidding amounts, constructing customized advertisements and landing pages for individual visitors, analyzing visitor responses, etc.

FIG. 5 illustrates an example computer system 500. In particular embodiments, one or more computer systems 500 perform one or more steps of one or more methods described or illustrated herein. In particular embodiments, one or more computer systems 500 provide functionality described or illustrated herein. In particular embodiments, software running on one or more computer systems 500 performs one or more steps of one or more methods described or illustrated herein or provides functionality described or illustrated herein. Particular embodiments include one or more portions of one or more computer systems 500.

This disclosure contemplates any suitable number of computer systems 500. This disclosure contemplates computer system 500 taking any suitable physical form. As example and not by way of limitation, computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time or in batch mode one or more steps of one or more methods described or illustrated herein. One or more computer systems 500 may perform at different times or at different locations one or more steps of one or more methods described or illustrated herein, where appropriate.

In particular embodiments, computer system 500 includes a processor 502, memory 504, storage 506, an input/output (I/O) interface 508, a communication interface 510, and a bus 512. Although this disclosure describes and illustrates a particular computer system having a particular number of particular components in a particular arrangement, this disclosure contemplates any suitable computer system having any suitable number of any suitable components in any suitable arrangement.

In particular embodiments, processor 502 includes hardware for executing instructions, such as those making up a computer program. As an example and not by way of limitation, to execute instructions, processor 502 may retrieve (or fetch) the instructions from an internal register, an internal cache, memory 504, or storage 506; decode and execute them; and then write one or more results to an internal register, an internal cache, memory 504, or storage 506. In particular embodiments, processor 502 may include one or more internal caches for data, instructions, or addresses. This disclosure contemplates processor 502 including any suitable number of any suitable internal caches, where appropriate. As an example and not by way of limitation, processor 502 may include one or more instruction caches, one or more data caches, and one or more translation lookaside buffers (TLBs). Instructions in the instruction caches may be copies of instructions in memory 504 or storage 506, and the instruction caches may speed up retrieval of those instructions by processor 502. Data in the data caches may be copies of data in memory 504 or storage 506 for instructions executing at processor 502 to operate on; the results of previous instructions executed at processor 502 for access by subsequent instructions executing at processor 502 or for writing to memory 504 or storage 506; or other suitable data. The data caches may speed up read or write operations by processor 502. The TLBs may speed up virtual-address translation for processor 502. In particular embodiments, processor 502 may include one or more internal registers for data, instructions, or addresses. This disclosure contemplates processor 502 including any suitable number of any suitable internal registers, where appropriate. Where appropriate, processor 502 may include one or more arithmetic logic units (ALUs); be a multi-core processor; or include one or more processors 502. Although this disclosure describes and illustrates a particular processor, this disclosure contemplates any suitable processor.

In particular embodiments, memory 504 includes main memory for storing instructions for processor 502 to execute or data for processor 502 to operate on. As an example and not by way of limitation, computer system 500 may load instructions from storage 506 or another source (such as, for example, another computer system 500) to memory 504. Processor 502 may then load the instructions from memory 504 to an internal register or internal cache. To execute the instructions, processor 502 may retrieve the instructions from the internal register or internal cache and decode them. During or after execution of the instructions, processor 502 may write one or more results (which may be intermediate or final results) to the internal register or internal cache. Processor 502 may then write one or more of those results to memory 504. In particular embodiments, processor 502 executes only instructions in one or more internal registers or internal caches or in memory 504 (as opposed to storage 506 or elsewhere) and operates only on data in one or more internal registers or internal caches or in memory 504 (as opposed to storage 506 or elsewhere). One or more memory buses (which may each include an address bus and a data bus) may couple processor 502 to memory 504. Bus 512 may include one or more memory buses, as described below. In particular embodiments, one or more memory management units (MMUs) reside between processor 502 and memory 504 and facilitate accesses to memory 504 requested by processor 502. In particular embodiments, memory 504 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 504 may include one or more memories 504, where appropriate. Although this disclosure describes and illustrates particular memory, this disclosure contemplates any suitable memory.

In particular embodiments, storage 506 includes mass storage for data or instructions. As an example and not by way of limitation, storage 506 may include an HDD, a floppy disk drive, flash memory, an optical disc, a magneto-optical disc, magnetic tape, or a Universal Serial Bus (USB) drive or a combination of two or more of these. Storage 506 may include removable or non-removable (or fixed) media, where appropriate. Storage 506 may be internal or external to computer system 500, where appropriate. In particular embodiments, storage 506 is non-volatile, solid-state memory. In particular embodiments, storage 506 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 506 taking any suitable physical form. Storage 506 may include one or more storage control units facilitating communication between processor 502 and storage 506, where appropriate. Where appropriate, storage 506 may include one or more storages 506. Although this disclosure describes and illustrates particular storage, this disclosure contemplates any suitable storage.

In particular embodiments, I/O interface 508 includes hardware, software, or both providing one or more interfaces for communication between computer system 500 and one or more I/O devices. Computer system 500 may include one or more of these I/O devices, where appropriate. One or more of these I/O devices may enable communication between a person and computer system 500. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 508 for them. Where appropriate, I/O interface 508 may include one or more device or software drivers enabling processor 502 to drive one or more of these I/O devices. I/O interface 508 may include one or more I/O interfaces 508, where appropriate. Although this disclosure describes and illustrates a particular I/O interface, this disclosure contemplates any suitable I/O interface.

In particular embodiments, communication interface 510 includes hardware, software, or both providing one or more interfaces for communication (such as, for example, packet-based communication) between computer system 500 and one or more other computer systems 500 or one or more networks. As an example and not by way of limitation, communication interface 510 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 510 for it. As an example and not by way of limitation, computer system 500 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 500 may include any suitable communication interface 510 for any of these networks, where appropriate. Communication interface 510 may include one or more communication interfaces 510, where appropriate. Although this disclosure describes and illustrates a particular communication interface, this disclosure contemplates any suitable communication interface.

In particular embodiments, bus 512 includes hardware, software, or both coupling components of computer system 500 to each other. As an example and not by way of limitation, bus 512 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or another suitable bus or a combination of two or more of these. Bus 512 may include one or more buses 512, where appropriate. Although this disclosure describes and illustrates a particular bus, this disclosure contemplates any suitable bus or interconnect.

Herein, reference to a computer-readable storage medium encompasses one or more non-transitory, tangible computer-readable storage media possessing structure. As an example and not by way of limitation, a computer-readable storage medium may include a semiconductor-based or other integrated circuit (IC) (such, as for example, a field-programmable gate array (FPGA) or an application-specific IC (ASIC)), a hard disk, an HDD, a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, or another suitable computer-readable storage medium or a combination of two or more of these, where appropriate. Herein, reference to a computer-readable storage medium excludes any medium that is not eligible for patent protection under 35 U.S.C. §101. Herein, reference to a computer-readable storage medium excludes transitory forms of signal transmission (such as a propagating electrical or electromagnetic signal per se) to the extent that they are not eligible for patent protection under 35 U.S.C. §101. A computer-readable non-transitory storage medium may be volatile, non-volatile, or a combination of volatile and non-volatile, where appropriate.

This disclosure contemplates one or more computer-readable storage media implementing any suitable storage. In particular embodiments, a computer-readable storage medium implements one or more portions of processor 502 (such as, for example, one or more internal registers or caches), one or more portions of memory 504, one or more portions of storage 506, or a combination of these, where appropriate. In particular embodiments, a computer-readable storage medium implements RAM or ROM. In particular embodiments, a computer-readable storage medium implements volatile or persistent memory. In particular embodiments, one or more computer-readable storage media embody software. Herein, reference to software may encompass one or more applications, bytecode, one or more computer programs, one or more executables, one or more instructions, logic, machine code, one or more scripts, or source code, and vice versa, where appropriate. In particular embodiments, software includes one or more application programming interfaces (APIs). This disclosure contemplates any suitable software written or otherwise expressed in any suitable programming language or combination of programming languages. In particular embodiments, software is expressed as source code or object code. In particular embodiments, software is expressed in a higher-level programming language, such as, for example, C, Perl, or a suitable extension thereof. In particular embodiments, software is expressed in a lower-level programming language, such as assembly language (or machine code). In particular embodiments, software is expressed in JAVA. In particular embodiments, software is expressed in Hyper Text Markup Language (HTML), Extensible Markup Language (XML), or other suitable markup language.

### Miscellaneous

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Furthermore, “a”, “an,” or “the” is intended to mean “one or more,” unless expressly indicated otherwise or indicated otherwise by context. Therefore, herein, “an A” or “the A” means “one or more A,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, this disclosure encompasses any suitable combination of one or more features from any example embodiment with one or more features of any other example embodiment herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising: by one or more computing devices,
deriving one or more user intents from user information associated with a user;
selecting, from a plurality of advertiser intents, one or more advertiser intents that align with the one or more user intents; and
advertising to the user based on the one or more advertiser intents that align with the one or more user intents.

2. The method of claim 1, wherein the user information associated with the user comprises explicit user information and implicit user information associated with the user.

3. The method of claim 2, wherein the explicit user information associated with the user comprises one or more of:
present online activities of the user;
past online activities of the user;
present offline activities of the user;
past offline activities of the user;
demographic information of the user; or
social-networking information of the user.

4. The method of claim 3, wherein the present online activities of the user comprise one or more search queries submitted by the user.

5. The method of claim 2, wherein the implicit user information associated with the user comprises one or more of:
a present location of a device associated with the user;
one or more past locations of one or more devices associated with the user;
a present time when the device is at the present location; or
one or more past times when the one or more devices are at the one or more past locations respectively.

6. The method of claim 1, wherein the one or more user intents comprises one or more primary user intents and one or more secondary user intents.

7. The method of claim 1, wherein deriving the one or more user intents from the user information associated with the user comprises:
parsing a query submitted by the user to determine one or more words or one or more sets of words; and
determining one or more intents included in the query based on the one or more words or the one or more sets of words.

8. The method of claim 1, wherein deriving the one or more user intents from the user information associated with the user comprises:
receiving one or more user intents from one or more advertising publishers,
wherein:
each of the one or more user intents is represented as a name-value pair; and
the one or more user intents are received through an Application Programming Interface.

9. The method of claim 1, wherein deriving the one or more user intents from the user information associated with the user comprises pre-crawling one or more websites associated with one or more advertising publishers to determine one or more intents associated with the user in connection with one or more Uniform Resource Locators associated with the one or more websites.

10. The method of claim 1, wherein deriving the one or more user intents from the user information associated with the user comprises crawling one or more web pages associated with one or more advertising publishers in real-time to determine one or more intents associated with the user in connection with the one or more web pages.

11. The method of claim 1, wherein deriving the one or more user intents from the user information associated with the user comprises inferring one or more geographic intents of the user based on one or more locations of the user.

12. The method of claim 1, wherein selecting, from the plurality of advertiser intents, the one or more advertiser intents that align with the one or more user intents comprises:
deriving a plurality of keywords from the plurality of advertiser intents;
matching one or more of the plurality of keywords with the one or more user intents; and
selecting one or more of the plurality of advertiser intents from which the one or more of the plurality of keywords are derived.

13. The method of claim 1, wherein one or more advertisers place one or more bids on one or more specific advertiser intents from the plurality of advertiser intents,
wherein each of the one or more bids comprises an advertisement, a condition, and a maximum payment amount that an advertiser placing the bid agrees to pay when the condition is satisfied.

14. The method of claim 13, wherein advertising to the user based on the one or more advertiser intents comprises:
selecting, from the one or more bids and for the user, at least one bid placed on the one or more advertiser intents that align with the one or more user intents.

15. The method of claim 14, wherein advertising to the user based on the one or more advertiser intents further comprises:
for each of the at least one bid selected for the user, presenting the advertisement of the bid to the user.

16. The method of claim 15, wherein for each of the at least one bid selected for the user, presenting the advertisement of the bid to the user comprises:
sending the advertisement to an electronic device associated with the user for presentation to the user.

17. The method of claim 15, wherein selecting, from the one or more bids and for the user, the at least one bid placed on the one or more advertiser intents that align with the one or more user intents comprises:
for each of the one or more bids, determining a degree of match between the one or more advertiser intents and the one or more specific advertiser intents on which the bid is placed; and
comparing the one or more bids based on the degree of match determined for each of the one or more bids.

18. The method of claim 15, wherein selecting, from the one or more bids and for the user, the at least one bid placed on the one or more advertiser intents that align with the one or more user intents comprises:
for each of the one or more bids, estimating a compensation to a publisher for presenting the advertisement of the bid to the user; and
comparing the one or more bids based on the compensation estimated for each of the one or more bids.

19. The method of claim 13, wherein each condition comprises one or more of:
any user completes a transaction subsequent to interacting with an advertisement presented to that user, wherein the advertisement is associated with one of the one or more bids associated with the condition;
any user interacts with an advertisement presented to that user, wherein the advertisement is associated with one of the one or more bids associated with the condition; or
one or more specific advertisements are matched to one or more users for a predetermined number of times, wherein the one or more specific advertisements are each associated with at least one of the one or more bids associated with the condition.

20. The method of claim 13, further comprising for each of the one or more bids placed on the one or more specific advertiser intents, if the condition of the bid is satisfied, then charging an advertiser placing the bid an amount less than or equal to the maximum payment amount of the bid.

21. The method of claim 1, further comprising:
identifying the plurality of advertiser intents for a plurality of products;
matching one or more of the plurality of products from which the one or more advertiser intents that align with the one or more user intents are identified with the user; and
recommending the one or more products to the user.

22. The method of claim 21, wherein recommending the one or more products to the user comprises sending one or more advertisements of the one or more products to an electronic device associated with the user for presentation to the user.

23. The method of claim 22, wherein a product is a physical product, a software product, or a service.

24. A system comprising:
a memory comprising instructions executable by one or more processors; and
the one or more processors coupled to the memory and operable to execute the instructions, the one or more processors being operable when executing the instructions to:
derive one or more user intents from user information associated with a user;
select, from a plurality of advertiser intents, one or more advertiser intents that align with the one or more user intents; and
advertise to the user based on the one or more advertiser intents that align with the one or more user intents.

25. The system of claim 24, wherein the user information associated with the user comprises explicit user information and implicit user information associated with the user.

26. The system of claim 25, wherein the explicit user information associated with the user comprises one or more of:
present online activities of the user;
past online activities of the user;
present offline activities of the user;
past offline activities of the user;
demographic information of the user; or
social-networking information of the user.

27. The system of claim 26, wherein the present online activities of the user comprise one or more search queries submitted by the user.

28. The system of claim 25, wherein the implicit user information associated with the user comprises one or more of:
a present location of a device associated with the user;
one or more past locations of one or more devices associated with the user;
a present time when the device is at the present location; or
one or more past times when the one or more devices are at the one or more past locations respectively.

29. The system of claim 24, wherein the one or more user intents comprises one or more primary user intents and one or more secondary user intents.

30. The system of claim 24, wherein deriving the one or more user intents from the user information associated with the user comprises:
parse a query submitted by the user to determine one or more words or one or more sets of words; and
determine one or more intents included in the query based on the one or more words or the one or more sets of words.

31. The system of claim 24, wherein deriving the one or more user intents from the user information associated with the user comprises:
receive one or more user intents from one or more advertising publishers,
wherein:
each of the one or more user intents is represented as a name-value pair; and
the one or more user intents are received through an Application Programming Interface.

32. The system of claim 24, wherein deriving the one or more user intents from the user information associated with the user comprises pre-crawl one or more websites associated with one or more advertising publishers to determine one or more intents associated with the user in connection with one or more Uniform Resource Locators associated with the one or more websites.

33. The system of claim 24, wherein deriving the one or more user intents from the user information associated with the user comprises crawl one or more web pages associated with one or more advertising publishers in real-time to determine one or more intents associated with the user in connection with the one or more web pages.

34. The system of claim 24, wherein deriving the one or more user intents from the user information associated with the user comprises infer one or more geographic intents of the user based on one or more locations of the user.

35. The system of claim 24, wherein selecting, from the plurality of advertiser intents, the one or more advertiser intents that align with the one or more user intents comprises:
derive a plurality of keywords from the plurality of advertiser intents;
match one or more of the plurality of keywords with the one or more user intents; and
select one or more of the plurality of advertiser intents from which the one or more of the plurality of keywords are derived.

36. The system of claim 24, wherein one or more advertisers place one or more bids on one or more specific advertiser intents from the plurality of advertiser intents,
wherein each of the one or more bids comprises an advertisement, a condition, and a maximum payment amount that an advertiser placing the bid agrees to pay when the condition is satisfied.

37. The system of claim 36, wherein advertising to the user based on the one or more advertiser intents comprises:
select, from the one or more bids and for the user, at least one bid placed on the one or more advertiser intents that align with the one or more user intents.

38. The system of claim 37, wherein advertising to the user based on the one or more advertiser intents further comprises:
for each of the at least one bid selected for the user, present the advertisement of the bid to the user.

39. The system of claim 37, wherein for each of the at least one bid selected for the user, presenting the advertisement of the bid to the user comprises:
send the advertisement to an electronic device associated with the user for presentation to the user.

40. The system of claim 37, wherein selecting, from the one or more bids and for the user, the at least one bid placed on the one or more advertiser intents that align with the one or more user intents comprises:
for each of the one or more bids, determine a degree of match between the one or more advertiser intents and the one or more specific advertiser intents on which the bid is placed; and
compare the one or more bids based on the degree of match determined for each of the one or more bids.

41. The system of claim 37, wherein selecting, from the one or more bids and for the user, the at least one bid placed on the one or more advertiser intents that align with the one or more user intents comprises:
for each of the one or more bids, estimate a compensation to a publisher for presenting the advertisement of the bid to the user; and
compare the one or more bids based on the compensation estimated for each of the one or more bids.

42. The system of claim 36, wherein each condition comprises one or more of:
any user completes a transaction subsequent to interacting with an advertisement presented to that user, wherein the advertisement is associated with one of the one or more bids associated with the condition;
any user interacts with an advertisement presented to that user, wherein the advertisement is associated with one of the one or more bids associated with the condition; or
one or more specific advertisements are matched to one or more users for a predetermined number of times, wherein the one or more specific advertisements are each associated with at least one of the one or more bids associated with the condition.

43. The system of claim 36, wherein the one or more processors are further operable when executing the instructions to for each of the one or more bids placed on the one or more specific advertiser intents, if the condition of the bid is satisfied, then charge an advertiser placing the bid an amount less than or equal to the maximum payment amount of the bid.

44. The system of claim 24, wherein the one or more processors are further operable when executing the instructions to:
identify the plurality of advertiser intents for a plurality of products;
match one or more of the plurality of products from which the one or more advertiser intents that align with the one or more user intents are identified with the user; and
recommend the one or more products to the user.

45. The system of claim 44, wherein recommending the one or more products to the user comprises send one or more advertisements of the one or more products to an electronic device associated with the user for presentation to the user.

46. The system of claim 45, wherein a product is a physical product, a software product, or a service.

47. One or more computer-readable non-transitory storage media embodying software operable when executed by one or more computer systems to:
derive one or more user intents from user information associated with a user;
select, from a plurality of advertiser intents, one or more advertiser intents that align with the one or more user intents; and
advertise to the user based on the one or more advertiser intents that align with the one or more user intents.

48. The media of claim 47, wherein the user information associated with the user comprises explicit user information and implicit user information associated with the user.

49. The media of claim 48, wherein the explicit user information associated with the user comprises one or more of:
present online activities of the user;
past online activities of the user;
present offline activities of the user;
past offline activities of the user;
demographic information of the user; or
social-networking information of the user.

50. The media of claim 49, wherein the present online activities of the user comprise one or more search queries submitted by the user.

51. The media of claim 48, wherein the implicit user information associated with the user comprises one or more of:
a present location of a device associated with the user;
one or more past locations of one or more devices associated with the user;
a present time when the device is at the present location; or
one or more past times when the one or more devices are at the one or more past locations respectively.

52. The media of claim 47, wherein the one or more user intents comprises one or more primary user intents and one or more secondary user intents.

53. The media of claim 47, wherein deriving the one or more user intents from the user information associated with the user comprises:
parse a query submitted by the user to determine one or more words or one or more sets of words; and
determine one or more intents included in the query based on the one or more words or the one or more sets of words.

54. The media of claim 47, wherein deriving the one or more user intents from the user information associated with the user comprises:
receive one or more user intents from one or more advertising publishers,
wherein:
each of the one or more user intents is represented as a name-value pair; and
the one or more user intents are received through an Application Programming Interface.

55. The media of claim 47, wherein deriving the one or more user intents from the user information associated with the user comprises pre-crawl one or more websites associated with one or more advertising publishers to determine one or more intents associated with the user in connection with one or more Uniform Resource Locators associated with the one or more websites.

56. The media of claim 47, wherein deriving the one or more user intents from the user information associated with the user comprises crawl one or more web pages associated with one or more advertising publishers in real-time to determine one or more intents associated with the user in connection with the one or more web pages.

57. The media of claim 47, wherein deriving the one or more user intents from the user information associated with the user comprises infer one or more geographic intents of the user based on one or more locations of the user.

58. The media of claim 47, wherein selecting, from the plurality of advertiser intents, the one or more advertiser intents that align with the one or more user intents comprises:
derive a plurality of keywords from the plurality of advertiser intents;
match one or more of the plurality of keywords with the one or more user intents; and
select one or more of the plurality of advertiser intents from which the one or more of the plurality of keywords are derived.

59. The media of claim 47, wherein one or more advertisers place one or more bids on one or more specific advertiser intents from the plurality of advertiser intents,
wherein each of the one or more bids comprises an advertisement, a condition, and a maximum payment amount that an advertiser placing the bid agrees to pay when the condition is satisfied.

60. The media of claim 59, wherein advertising to the user based on the one or more advertiser intents comprises:
select, from the one or more bids and for the user, at least one bid placed on the one or more advertiser intents that align with the one or more user intents.

61. The media of claim 60, wherein advertising to the user based on the one or more advertiser intents further comprises:
for each of the at least one bid selected for the user, present the advertisement of the bid to the user.

62. The media of claim 60, wherein for each of the at least one bid selected for the user, presenting the advertisement of the bid to the user comprises:
send the advertisement to an electronic device associated with the user for presentation to the user.

63. The media of claim 60, wherein selecting, from the one or more bids and for the user, the at least one bid placed on the one or more advertiser intents that align with the one or more user intents comprises:
for each of the one or more bids, determine a degree of match between the one or more advertiser intents and the one or more specific advertiser intents on which the bid is placed; and
compare the one or more bids based on the degree of match determined for each of the one or more bids.

64. The media of claim 60, wherein selecting, from the one or more bids and for the user, the at least one bid placed on the one or more advertiser intents that align with the one or more user intents comprises:
for each of the one or more bids, estimate a compensation to a publisher for presenting the advertisement of the bid to the user; and
compare the one or more bids based on the compensation estimated for each of the one or more bids.

65. The media of claim 59, wherein each condition comprises one or more of:
any user completes a transaction subsequent to interacting with an advertisement presented to that user, wherein the advertisement is associated with one of the one or more bids associated with the condition;
any user interacts with an advertisement presented to that user, wherein the advertisement is associated with one of the one or more bids associated with the condition; or
one or more specific advertisements are matched to one or more users for a predetermined number of times, wherein the one or more specific advertisements are each associated with at least one of the one or more bids associated with the condition.

66. The media of claim 59, wherein the software is further operable when executed by the one or more computer systems to for each of the one or more bids placed on the one or more specific advertiser intents, if the condition of the bid is satisfied, then charge an advertiser placing the bid an amount less than or equal to the maximum payment amount of the bid.

67. The media of claim 47, wherein the software is further operable when executed by the one or more computer systems to:
identify the plurality of advertiser intents for a plurality of products;
match one or more of the plurality of products from which the one or more advertiser intents that align with the one or more user intents are identified with the user; and
recommend the one or more products to the user.

68. The media of claim 67, wherein recommending the one or more products to the user comprises send one or more advertisements of the one or more products to an electronic device associated with the user for presentation to the user.

69. The media of claim 68, wherein a product is a physical product, a software product, or a service.

70. A system comprising:
means for deriving one or more user intents from user information associated with a user;
means for selecting, from a plurality of advertiser intents, one or more advertiser intents that align with the one or more user intents; and
means for advertising to the user based on the one or more advertiser intents that align with the one or more user intents.
